(19) United States
(12) Patent Application Publication
(10) Pub. No.: US 2012/0265828 A1
(43) Pub. Date: Oct. 18, 2012

(54) HOME BRIDGE SYSTEM AND METHOD OF DELIVERING CONFIDENTIAL ELECTRONIC FILES

(76) Inventors: Igor SLEPININ, West Hartford, CT (US); Clifford F. BOYLE, Scottsdale, AZ (US); Robert E. MCGILL, Rumson, NJ (US)

(21) Appl. No.: 13/445,188

(22) Filed: Apr. 12, 2012

Related U.S. Application Data
(63) Continuation-in-part of application No. 13/097,922, filed on Apr. 29, 2011.
(60) Provisional application No. 61/474,511, filed on Apr. 12, 2011.

(51) Int. Cl. G06F 15/16

(52) U.S. Cl. 709/206

(57) ABSTRACT

A private document delivery system and method includes a home bridge computer configured to securely deliver an electronic document over a computer network. The home bridge computer combines SSL security, authentication, and direct data transfer in a link delivery system to maintain security of private electronic documents. The private electronic documents and messages transmitted via the home bridge computer are not stored during transit on the computer network, and no third parties to the message receive a permanent copy of the message. The systems and methods also include signaling mechanisms configured to notify the receiving computer that the electronic document is awaiting delivery. The system and method includes a network registry configured to verify the receiving computer's identity with a protocol specified by the sending computer and to provide access instructions to the receiving computer with which the receiving computer locates the home bridge and retrieves the private message.

### CROSS-REFERENCE TO RELATED APPLICATIONS

This application claims priority to U.S. Provisional Patent Application No. 61/474,511, filed on Apr. 12, 2011, the entire contents of which are incorporated herein by reference. This application is a continuation-in-part application of, and also claims priority to, U.S. patent application Ser. No. 13/097,922, filed on Apr. 29, 2011, the entire contents of which are incorporated herein by reference.

### TECHNICAL FIELD

This technology generally relates to computer security and more specifically to electronically delivering confidential documents, messages, and attachments.

### BACKGROUND

Electronic mail (e-mail) systems are used to compose, send, and receive messages between computing devices over a computer network. Authors and recipients use e-mail systems to exchange digital messages over computer networks such as the Internet. E-mail may be the most heavily used feature of the Internet. Millions of people send and receive e-mail every day. When a user sends an email message, an Internet standard for electronic mail, such as Simple Mail Transfer Protocol (SMTP) sends the message to a mail server for relaying. The transmitted message is broken into packets over a transmission control protocol (TCP) connection, and the Internet protocol (IP) delivers the packets to the proper location(s), and the TCP then reassembles the message at the receiving computing device so that a recipient can read the message.

E-mail messages can include one or more attachments, in the form of documents or files. When sending email messages with attached documents or files, the attachments and files are often encoded using an Internet standard such as Multipurpose Internet Mail Extensions (MIME). MIME extends the format of e-mail to support non-standard character sets, non-text attachments, messages bodies with multiple parts, header information, and the like. When the email message is received by the recipient, the attachment(s) are decoded in a similar fashion.

In the past, electronic mail transmission and delivery was not secure. Transmission and delivery of email messages was often routed through intermediate relay points, such as mail submission agents, DNS servers, message transfer agents, message delivery agents, and other servers used to bridge smaller networks. Often, persistent copies of the email message are made and potentially stored at the intermediate relay points. Nefarious characters could read email messages when these messages traveled on public networks. Other ne'er do wells could intercept email messages and change the contents of the message between the time the sender composes the message and the time the recipient reads it. Encrypting email messages by scrambling the message provided a measure of success in ensuring that only the sender and receiver could read the messages. One type of encryption uses software keys with which to encrypt email messages. The keys include a public key and a private key. The public key is available for anyone to use to encrypt the email message when sending it, but only a recipient that holds a private key is able to decrypt the email message to read it. In practice, the communication can start with one side generating and sending a symmetric “session” key encrypted with a known public key of a recipient. Only the recipient can decrypt this message, so the session key is “safe” as it is transmitted in encrypted form. Once the recipient receives the session key, the sender and the recipient can use the session key to apply the encryption algorithm to send and receive email messages to and from each other. The email messages are sent over the computer network. While the email is on the computer network, the email is encrypted so that any shady character that reads the email will not be able to understand it.

When verifying that the contents of a message were written by a particular user and unaltered by any other user, it is necessary to agree upon a signature and hash algorithm. The signature is used to verify the authenticity of the message, and the hash algorithm is used to verify the integrity of the message.

For signature algorithms, asymmetric algorithms are typically used. These algorithms utilize a public key and a secret key. A signature algorithm combined with a secret key allows someone to generate a digital signature for the contents of a message. The party that anticipates receiving an email message creates the public key and the associated secret key. When another party wants to send a secure email to the creator of the keys, that party encrypts the email using the recipient's public key and sends the message. The recipient decrypts the message using the private key. The need to exchange asymmetric key pair information prior to sending a secure email creates network friction that has restricted secure email adoption to a very small specialized market. A signature algorithm combined with a public key allows someone to verify the digital signature for a message. Signature algorithms are one way functions. A user cannot reconstruct the input to a signature function by looking at its output.

Hash algorithms are also called message digest algorithms. These algorithms compute a checksum on their input; no keys are involved. Hash algorithms are also one way functions, and a robust hash algorithm is one in which very similar inputs produce dramatically different outputs. For example, if even a single bit of the message file is altered or corrupted in transit, the hash value should be very different.

Digital certificates also provide an additional level of security. Digital certificates use a digital signature to bind a public key with an identity. The certificate can be used to verify that a public key belongs to a particular individual and that individual is who he says he is. Digital certificates place information on a sender or a recipient's computer and use encryption to create a unique digital certificate for that person from the stored information. When that person goes to a web site or sends an email, the digital certificate is presented to the site or attached to the email, and the certificate verifies that the user is who he claims to be.

However, not all email programs are good at reading signed or encrypted email. An additional encryption/decryption piece of software is required to provide this functionality. Further, if a recipient does not have a valid certificate, or has conflicting or unsupported encryption capabilities, the email message will not be properly received or viewed.

Also, many e-mail systems and methods do not provide verification that an electronic message was received by the intended recipient nor do they provide the sender of the email with an authentication message to indicate that the delivered message was not intercepted or altered. In these current email systems, the message sender cannot demonstrate that the intended receiver actually received the encrypted message sent. The server from which the email was originally sent has to trust that the system and user requesting an encryption key associated with the email previously transmitted actually has the message that corresponds to the encryption key. Confidential email with suitable tracking verification and authentication is not provided. Additionally, private messaging—that is, the ability to send messages without others knowing you are doing so—is not possible with current messaging schemes.

A secure email program should be nonintrusive and transparent. Different approaches have been used in the past to provide secure email transmission and delivery.

### SUMMARY

In this disclosure, many of the examples discuss systems and methods used to provide, send, and deliver documents between computing devices on disparate networks. However, it should be understood that the systems and techniques in accordance with the claimed invention can also provide secure transmission, reception, and storage of electronic files and documents within a single computer or a single computer network, depending upon the sending computer and the receiving computer. Additionally, multiple receiving computers can be employed, such as when a secure electronic mail message is sent to multiple recipients, for example.

One example of the claimed invention is a system and method for delivering confidential e-mail messages and attachments that combines secure socket layer security, authentication, and direct data transfer with a link delivery system. The system protects e-mail messages from unwanted or unauthorized third parties. With the system and method of the claimed invention, only the sender and the intended recipient have a copy of the message. The e-mails are not stored on a server. Instead, all communications are routed through a home bridge appliance, ensuring the messages are always private. The home bridge can be a plug computer or a small form factor server and can be powered up at all times. The home bridge appliance can connect directly to a modem and act as a personal digital mailbox for e-mail communications. A memory device can be connected to the home bridge to provide additional storage capacity. Users can choose an appropriate physical storage location for the electronic communications and files where they will remain safeguarded until the user provides access to them.

One example of the claimed invention is a system and method for delivering confidential e-mail messages and attachments by establishing a persistent direct path between the sending computer and the receiving computer through a persistent home bridge appliance so that no third parties receive permanent or persistent copies of the confidential documents. The system and method establishes a direct path dynamically from the home bridge appliance to the receiving computer so that the receiving computer does not need to be a member of the sender's peer network, such as a private messaging network or the like. Additionally, because the private message is stored on the home bridge until it is delivered, the sending computer does not need to be on-line when delivery is made. Similarly, a home bridge device can be employed by the receiving computer to provide always-on capabilities to receive private messages when the receiving computer is not on-line. For example, the user of the receiving computer can view and edit messages on the home bridge device from any network location.

Peer networks are collections of computers that are registered on a central server or servers so that direct connections can be made between two of the registered computers. In the case of the claimed invention, private messages can also be sent between sending and receiving computers that are not on the same peer network. In one example, the receiving computer receives a notification with a link that establishes a direct connection to the home bridge appliance. This system and method provides a high degree of privacy by maintaining physical possession of the persisted data (e.g., email messages and attachments) strictly with the sending computer or the home bridge appliance and the receiving computer. Because no copies of the e-mail message or attachment(s) are ever persisted with outside parties, there is no need for encryption at rest. As such, there is no need for cumbersome asymmetrical key encryption.

The systems and methods of the claimed invention provide a secure manner for delivering confidential electronic files and documents, such as e-mail messages and attachments, by notifying a recipient that a message is waiting to be retrieved. Identification information is received from the recipient and verified by the home bridge appliance. A specific verification protocol can be identified and employed. Once the recipient is verified, access instructions are provided to the recipient. A direct connection is established dynamically, and the secure private transmission and delivery of the private electronic document is effected via the direct connection.

When the recipient is not a member of the sender's peer network, or when the recipient's receiving computer is not on-line, the secure document delivery system and method can send the private message directly between a sender and a recipient using a signaling mechanism, such as a traditional SMTP email message, for example, to notify a recipient that a message is waiting. The private message is placed in a folder on the home bridge appliance to await delivery to the recipient. The recipient's identity is verified with a protocol specified by the sender. The protocol can be a third party identify verification agent such as a private email registry and the like. Once the recipient is authenticated, the private email registry or other verification agent passes the location information and access instructions needed to receive the private message from the home bridge to the recipient.

Additionally, if the sending computer and the receiving computer happen to be members of the same peer network, additional signaling is not necessary, and the private message can be delivered directly over the encrypted line of the peer network. The direct delivery of the private message from the sending computer to the receiving computer is affected without a persistent copy of the message being stored on any intermediate devices. For example, the private message can be routed through a mail submission agent, a mail user agent, and/or a message relay server accessible to both the sending computer and the receiving computer, and none of these intermediate computers stores a copy of the message. The message persists only on the sending computer and the receiving computer. Pre-authorization of the sender can be used to establish a private direct-line to the receiving computer. When the sender is not authorized, a request for authorization can be sent to the receiving computer to grant the sender authorization.

Using these techniques, resilience patterns are opened up that increase the reliability of the direct transfer because the sender is able to send private documents from dynamic locations. A network registry can be used to track and to keep track of where the sender and receiver are located. For example, the network registry can track the IP addresses of the sending computer and receiving computer and their respective home bridge devices. Because the message itself is not stored at a third party agent (only the location of the message is stored) the contents of the message remain completely private. In addition, because the identity verification protocol can be specified by the sender, the third party agent does not know the identity of the recipient. The third party agent knows only that the recipient has passed an identity test or other verification test devised by the sender. Likewise, the third party agent will never know what content passes between the sender and the recipient.

An example private document delivery system includes a sending computer configured to transmit an electronic document over a computer network, a receiving computer, a home bridge appliance, and a dynamically established encrypted line to traverse the computer network from the receiving computer to the sending computer such that no third parties to the message receive a permanent copy of the message. The private document delivery system can also include a signaling mechanism configured to notify the receiving computer that the electronic document is waiting for delivery. The system can also includes a verification agent configured to verify the receiving computer's identity with a protocol specified by the sending computer and further configured to provide access instructions to the receiving computer. The receiving computer uses the access instructions to locate the sending computer via the dynamically established encrypted line and to receive the transmitted electronic document. The home bridge appliance can be used to hold the private message prior to delivering the message to the receiving computer.

One example of the private document delivery system performs a method of sending a message over a computer network that includes resolving the delivery address of the receiving computer at the time of transmission of the private message. An encrypted line is established from a receiving computer to a home bridge appliance of a sending computer, and the private message is transmitted from the home bridge appliance of the sending computer directly to the receiving computer over the encrypted line to the delivery address resolved at the time of transmission. The network location of the sending computer and/or the receiving computer is not resolved until the time the message is transmitted. That is, the exact network location of the receiving computer and/or the sending computer is not known to the other party until the private message is transmitted. The location of the sending computer is tracked by the network registry, which will locate the sender by using the sender's currently registered IP address. The sender (sending computer) is a member of the network and can use a user id and password as authentication means. Of course other types of information can also be used to authenticate the sending computer as a member of the network. If the sender moves, the sending computer software indicates a new sending computer (IP) address to the registry upon authentication. For example, when a message sender sends a message to a recipient, the message sender does not know where that recipient will be when he picks up the message. And when the recipient picks up the message, the recipient does not need to know the location of the sender when the sender transmitted the message. Additionally, the sending computer does not need to know when the receiving computer will pick up/receive the message. Likewise, the receiving computer does not need to know when the sending computer sent the message. That is, the time of transmission and/or receipt of the message may also be indeterminate. For example, a sender may wish to send a private message to a particular receiver. The sender composes the message and selects a secure method of transmission. When the sender composed the message, the sender (and the sending computer) did not know the network address of the receiving computer. However, when the receiver initiates the transmission of the private message, the sending computer employs the network registry and resolves the network address of the receiving computer, establishes an encrypted line from the receiving computer to the home bridge, and delivers the private message. The receiver clicks on the link and pulls the message across.

The method also includes dynamically establishing the encrypted line from the receiving computer to the sending computer whereby no third parties to the private message receive a permanent or persistent copy of the message.

In cases where the receiving computer is not on the same peer network as the sending computer, or if the sending computer determines that the receiving computer is not presently available to receive the message (for example, the receiving computer is not on-line), the method of sending the message over a computer network can also include the sending computer signaling the receiving computer to inform the receiving computer that a message is waiting for it. The private message can be placed on the home bridge to await delivery to the recipient. For example, the sending computer can signal the receiving computer that a message is waiting by notifying the receiving computer by email, instant message, short message service (SMS), and the like. Likewise, when the recipient is a member of the network, a flag can be set in the system registry to notify the receiving computer that a message is waiting on the home bridge to be delivered. When the receiving computer comes back on line, it checks for waiting messages and receives a response with a location of the waiting message.

The method of sending the message over a computer network can also include the sending computer specifying a manner of authenticating the receiver to ensure the message is delivered to the correct recipient at a receiving computer. For example, the sending computer can specify a manner of authenticating the receiver that includes a single use unique link that expires in a predetermined amount of time. The process can include verification of the receiver as well, and if the unique link expires, the sender can be required to send it to the receiver again. The predetermined amount of time for the link can include a fixed time period or an elapsed time or can be based upon other triggers, such as time periods related to particular events, times of day, days of week, and the like. The sending computer specifying the manner of authentication can also include specifying a password that must be communicated to the recipient. The password can be delivered to the receiving computer in a non-private message letting the receiving computer know that a message is waiting to be picked up. The delivery of the password can be performed by email, SMS, and the like (inline) and/or on a separate message from the sending computer. Additionally, the sending computer can specify a third party authentication protocol to be used to ensure the message is delivered to the correct recipient. For example, the authentication can be provided to the receiver via a phone call, a separate text message, and other out-of-band media.

The method of sending the message over a computer network can also include tracking the network location (such as an IP address, for example) of the sending computer by a presence monitoring tool running on the Internet. For example, presence monitoring can be employed to determine when and where the sending computer and/or the receiving computer were on-line or otherwise available to send and/or receive messages. Presence monitoring can be performed by tracking the IP or network address of the sending computer and/or the receiving computer. The presence monitoring tool can be a component of the sending computer, the home bridge appliances, and/or the receiving computer or can be a separate device that can determine the IP or network address of the sending and receiving computers.

Also, the method can include staging the message on a secure message delivery service. Further, the method of delivery of the message over a computer network can be effected by “waking up” the sending computer and/or the receiving computer using “Wake on” technology, such as Wake-on-LAN, Wake on Wireless LAN, and the like. The sending computer and the receiving computer can be on separate local networks with separate local firewalls, and delivering the message is accomplished by hole-punching in the sender's local network firewall and the recipient's local network firewall. Hole punching can be used to establish communications between a sending computer and/or a receiving computer that is behind a restrictive firewall. The sending computer and the receiving computer can establish a connection with an unrestricted (e.g., third-party) server that uncovers external and internal address information for the sending computer and the receiving computer. Since each client (e.g., the sending computer and the receiving computer) initiated the request to the server, the server knows their respective IP addresses and port numbers assigned for that session. The server then shares one to the other. Having valid port numbers causes the firewalls to accept the incoming packets from each side, and the sending computer and the receiving computer can be addressed in this fashion.

In order to facilitate the direct message transmission when sender and/or recipient are behind firewalls with Network Address Translation (NAT) or other filters or restrictions that prevent establishing a direct connection between the sender and recipient, the method of sending the message over a computer network can also include delivering the message via a third computer which is accessible to both the sender's computer and the recipient's computer. This third computer can act as a mail relay computer to forward the private message from the home bridge of the sending computer to the receiving computer without storing a persistent copy of the private message. The mail relay computer acts as an agent between the sender's peer network and the receiver's network. This can include using a mail submission agent, a mail user agent, a message relay server accessible to both the sender and the receiver, and the like. Additionally, the method can further include marshaling this computer on demand to perform the mail submission agent, mail user agent, and message relay server functions and the like. The marshaling can be performed on demand.

The method of sending the message over a computer network can also include integrating the private message transmission from the sending computer directly to the receiving computer into other non-private delivery mechanisms such as email clients, web email services, instant messaging services, and the like. As outlined below, this integration can include incorporating private message functionality through the use of new buttons or other user interface options in an existing email client, web email service, instant messaging service and the like. The integrated private messaging functions can be deployed in these existing programs using plug-in functionality or other applications for adding functionality to a host program or host user interface.

The method of sending the message over a computer network can also include the use of mobile and portable computing devices, such as where the sending computer, the home bridge, and/or the receiving computer are laptop computers, notebook computers, tablet PCs, Internet tablets, personal digital assistants, smart phones, cellular telephones, carputers, and the like. These mobile and portable computing devices can include wireless access to a public network such as the Internet. Additionally, these devices can include synchronization features, multimedia functionality, database functionality, and other computer features.

In one example, a computer readable medium has instructions stored on it for sending messages over a computer network. A computer readable medium of the claimed invention includes computer-readable instructions stored on it to cause at least one processor to perform steps of establishing a medium for private electronic document exchanges outlined in the methods described above. For example, one computer readable storage media of the claimed invention can also include computer-readable instructions for sending a private message over a computer network where the instructions are configured to cause one or more computer processors to execute operations including resolving a delivery address of a receiving computer at the time of transmission of the private message, establishing an encrypted line from the receiving computer to a home bridge appliance of a sending computer, and transmitting the private message from the home bridge appliance of the sending computer directly to the receiving computer over the encrypted line to the delivery address resolved at the time of transmission.

The computer readable storage media of the claimed invention can also include computer-readable instructions configured to cause one or more computer processors to execute operations including dynamically establishing the encrypted line from the receiving computer to a home bridge appliance of the sending computer whereby no third parties to the private message receive a permanent copy of the private message. Further, the time of transmitting the private message can be indeterminate.

The computer readable storage media of the claimed invention can also include computer-readable instructions configured to cause one or more computer processors to execute operations including determining when a recipient of the private message on a receiving computer is a member of a private messaging network. Further, the instructions on the computer readable storage media can cause a computer processor to signal the receiving computer, by the sending computer, that a private message is waiting. Signaling the receiving computer can include notifying the receiving computer by at least one of email, Instant message, or short message service (SMS) or can be effected by the sending computer setting a flag for the receiving computer in a system registry database to let the receiving computer know that a message is waiting for it. Further, the instructions can address the case where the sender is a member of the private messaging network and the receiving computer is a non-member of the private messaging network, and the receiving computer is notified through a non-private message to directly access the private message from the sending computer. Likewise, the instructions can address the case where the sending computer and the receiving computer are members of the same private messaging network and track their network location and online status.

The computer readable storage media of the claimed invention can also include computer-readable instructions configured to cause one or more computer processors to execute operations including specifying an authentication, by the sending computer, to ensure the private message is delivered to the correct receiving computer. For example, specifying the authentication can include the sending computer specifying a single use unique link that expires in a predetermined amount of time. Additionally, specifying the authentication can include the sending computer providing an authentication to the notified receiving computer with the non-private message indicating that a private message is waiting for the receiving computer to access. Likewise, the authentication provided to the receiving computer can include a password with which the receiving computer gains access to the waiting private message. Further, the authentication can include the sending computer providing an authentication to the receiving computer separate from the non-private message indicating that a private message is waiting for the receiving computer. When executed by at least one processor, the instructions on the computer readable medium cause a processor to execute operations including specifying, by the sender, a third party authentication protocol to be used to ensure the message is delivered to the correct receiver.

When executed by at least one processor, the instructions on the computer readable medium cause a processor to execute operations, including tracking a network location of the sending computer and/or the receiving computer at the time of transmission using a presence monitoring tool. The presence monitoring tool can be a component of the sending computer, the home bridge appliances, and/or the receiving computer or can be a separate device that can determine the IP or network address of the sending and receiving computers. The network location of the sending computer and/or the receiving computer can be communicated to other interested network members by the presence monitoring tool.

The instructions on the computer readable medium further cause the processor to execute operations including delivering the private message to a secure message delivery service when the receiving computer is unavailable. For example, if the receiving computer of the private message recipient is off-line or otherwise unavailable, a secure message delivery service that is on-line at all times can be employed so that delivery of the private message can be guaranteed.

When executed by at least one processor, the instructions on the computer readable medium cause a processor to execute operations including delivering the private message by waking up the sending computer using at least one of Wake-on-LAN and Wake on Wireless LAN. The sending computer and the receiving computer can be on separate networks with separate firewalls, and the message can be delivered by hole-punching in the sender's local firewall and the recipient's local network firewall.

The computer readable storage media of the claimed invention can also include computer-readable instructions configured to cause one or more computer processors to execute operations to deliver the private message by a mail submission agent, a mail user agent, and/or a message relay server accessible to both the sending computer and the receiving computer, where no persistent copy of the private message is saved on the mail submission agent, mail user agent, or message relay server. The computer readable storage media of the claimed invention can also include computer-readable instructions configured to cause one or more processors to marshal the mail submission agent, mail user agent, and/or message relay server on demand.

As outlined above, when executed by at least one processor, the instructions on the computer readable medium cause a processor to integrate the transmission of the private message from the sending computer directly to the receiving computer into a non-private delivery mechanism-including email clients, web email services, and/or instant messaging services. Of course, the computer readable storage media of the claimed invention can also include computer-readable instructions configured to cause one or more computer processors to execute these operations where the sending computer and/or the receiving computer are mobile devices connected to a public network.

In each of the examples, the sending computer and/or the receiving computers can include clients that can be run inside of a web browser or outside of a web browser, such as by a web server in a private network. In all these environments, electronic documents, electronic mail, data files, programs, information, and computing resources can be accessed by a software application and retrieved and presented. Information resources, including the sending and receiving computers, and the network(s) to which they are connected, can be traversed regardless of whether the software application is a web browser, email client, or other application. Additionally, the techniques and processes described in the examples can also be performed when clients and servers are connected to multiple networks as well.

These and other advantages, aspects, and features will become more apparent from the following detailed description when viewed in conjunction with the accompanying drawings. A number of non-limiting and non-exhaustive embodiments are described with reference to the following drawings. Accordingly, the drawings and descriptions below are to be regarded as illustrative in nature, and not as restrictive.

### BRIEF DESCRIPTION OF THE DRAWINGS

FIG. 1 is an example computer system for delivering confidential electronic files using a home bridge in accordance with the claimed invention.

FIG. 2 illustrates a home bridge appliance registering with a system registry in accordance with the claimed invention.

FIGS. 3A-3C are a flow chart showing a process for delivering confidential electronic files using a computer system of FIG. 1.

FIG. 4 shows an example home bridge system for delivering confidential electronic files to a receiving computer that is outside the network of the sending computer.

FIG. 5 shows an example home bridge system with a sending computer checking the network registry to determine if a receiving computer is a member of the network registry.

FIG. 6 shows an example home bridge system and method for delivering confidential electronic files to a receiving computer that is not a member of the network registry.

FIG. 7 illustrates an example home bridge system where the receiving computer activates an embedded link in an email message as a private message request.

FIGS. 8, 9, and 10 show a home bridge system and method of sending a private message to a member of a peer-to-peer network without firewall constraints.

FIG. 11 shows an example method for delivering confidential instant messages (IM) to a receiving computer using a browser application in a system of the claimed invention.

FIG. 12 shows an example system and method for accessing confidential electronic documents, including private email messages, using remote mail access.

FIG. 13 shows schematically a system and method for a user to send a private message where the sender is unable to directly send the message to the receiving computer due to network constraints and where SMS is not supported.

FIG. 14 shows schematically a system and method for a user to send a private message where the sender is unable to directly send the message to the receiving computer due to network constraints but where SMS is supported.

FIG. 15 schematically illustrates a system and method for a user to send a private message using a home bridge relay when the user and/or the receiver is subject to network constraints and where SMS is not supported.

FIG. 16 schematically illustrates a system and method for a user to send a private message using a home bridge streaming relay when the user and/or the receiver is subject to network constraints and where SMS is not supported.

FIG. 17 schematically illustrates a system and method for a user to send a private message using a home bridge relay when the user and/or the receiver is subject to network constraints but where SMS is supported.

FIG. 18 schematically illustrates a system and method for a user to send a private message using a home bridge streaming relay when the user and/or the receiver is subject to network constraints but where SMS is supported.

FIG. 19 illustrates an addressable smart phone on registering as a home bridge device.

FIG. 20 illustrates a non-addressable smart phone on registering on a network.

FIG. 21 illustrates a home bridge device on a smart phone changing state.

FIG. 22 illustrates a smart phone sending a confidential message using a home bridge device in accordance with the claimed invention.

FIG. 23 shows an example confidential electronic document computing device in accordance with the claimed invention.

### DETAILED DESCRIPTION

When a computer user wants to send a confidential electronic document to another computer user, transfer mechanisms and processes provide many points along the delivery route where the confidential or private document could be compromised. An intuitive system and method for delivering confidential electronic documents, such as e-mail messages, attachments, applications, and the like, that establishes a direct path from the sending computer to the receiving computer through an encrypted line provides increased security, as no third parties receive permanent copies of the documents.

The transfer can be performed dynamically so that the receiving computer need not be a member of the same peer network as the sending computer and can receive a notification with a link that establishes a direct connection to the sending computer. In this fashion, privacy is maintained as physical possession of the persisted data is held strictly with the sending computer and with the receiving computer. No copies of the electronic data are ever persisted with outside parties, so there is no need for encryption at rest, and therefore there is no need for any cumbersome exchanges of encryption keys between users.

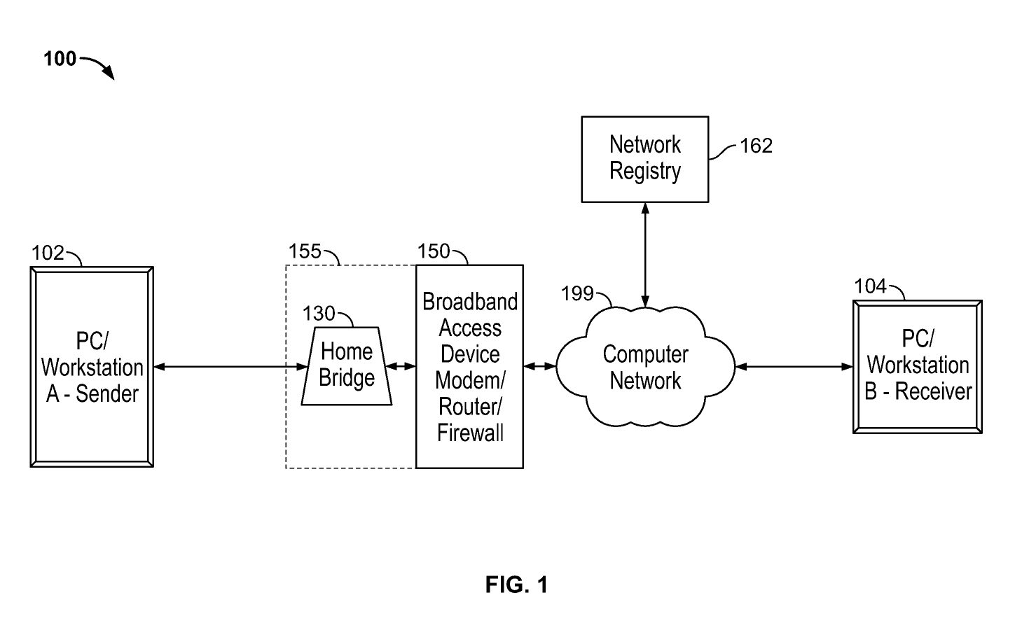

FIG. 1 is an exemplary private document delivery system 100 that that delivers confidential documents to a user. The private document delivery system 100 delivers confidential electronic documents from a sending computer 102 to a receiving computer 104 via home bridge appliance 130. The home bridge appliance 130 provides always-on persistence for messages and data sent and received over the computer network 199. The home bridge appliance 130 can be configured as a network-connected device to a broadband access device, such as broadband access device 150, and can perform functions including modem, router, switch, firewall, hub, network access point functions, and the like. Alternatively, the home bridge appliance 150 can be integrated with the broadband access device 150 as shown by dashed lines 155 in FIG. 1. A network registry, such as network registry 162 manages the system mail users, including sending computer 102 and receiving computer 104, as well as system relays (not shown in FIG. 1). System mail relays can include a service installed on user computers and can provide collective communication for end applications. The service can include a set of related application and software functionalities together with policies that control usage of the service. System mail relays also can provide a personal web user interface for a user attempting to access mail from a remote location. System mail relays can also be registered through network registry 162. Of course, multiple sending computers can be used in the system 100 and likewise, multiple receiving computer cans also be used in the system 100, such as when a sending computer 102 is sending a confidential electronic document to multiple receiving computers. Multiple sending computers can use the same home bridge to store and delivery private messages from each of the sending computers. Likewise, multiple receiving computers can use the same home bridge to receive and store private messages for each of the receiving computers. For clarity and brevity, a single sending computer 102 and a single receiving computer 104 is shown in FIG. 1.

Generally, sending computer 102 and receiving computer 104 can include any computing device capable of connecting to another computing device to send and receive information, including web-based information. These devices can include devices that typically connect using a wired and/or a wireless communications medium, such as personal computers, desktop computers, laptop computers, notebook computers, tablet PCs, Internet tablets, personal digital assistants, smart phones, cellular telephones, carputers, mobile phones, smart phones, personal digital assistants, and the like. These mobile and portable computing devices can include wireless access to a public network, such as the Internet. Additionally, these devices can include synchronization features, multimedia functionality, database functionality, and other computer features.

A system web client (not shown separately) is a mail and IM web client that provides a web interface for users away from their registered computers. The system web client can provide email and IM sending and receiving functionality via the network registry 162. Likewise, a system web IM Interface (not shown separately) provides an IM interface for users on computing devices that do not have or cannot have the system client installed. The system web IM interface can send and receive instant messages in conjunction with a system mail service.

The system mail service is a user-side service and interacts with the network registry 162. The system mail service interacts with the network registry 162 and provides system mail service registration functionality and user login capabilities in addition to providing communication for email plug-ins and other mail clients, such as Microsoft Outlook, Pegasus Mail, Mozilla Thunderbird, Apple Mail, JavaMail, GNU JavaMail, and the like. Additionally, an email plug-in (not shown separately) provides a user interface to send and receive electronic documents such as emails, instant messages, and the like.

In these examples, the computing devices can run web browsers that can provide an interface to make requests to different web server-based applications via the system 100. A series of web-based applications can run on the sending computer 102 and on the receiving computer 104 that facilitate the transmission of data. The sending computer 102 and the receiving computer 104 can be further configured to engage in a secure communication with other devices and/or each other using mechanisms such as Secure Sockets Layer (SSL), Internet Protocol Security (IPSec), Tunnel Layer Security (TLS), and the like.

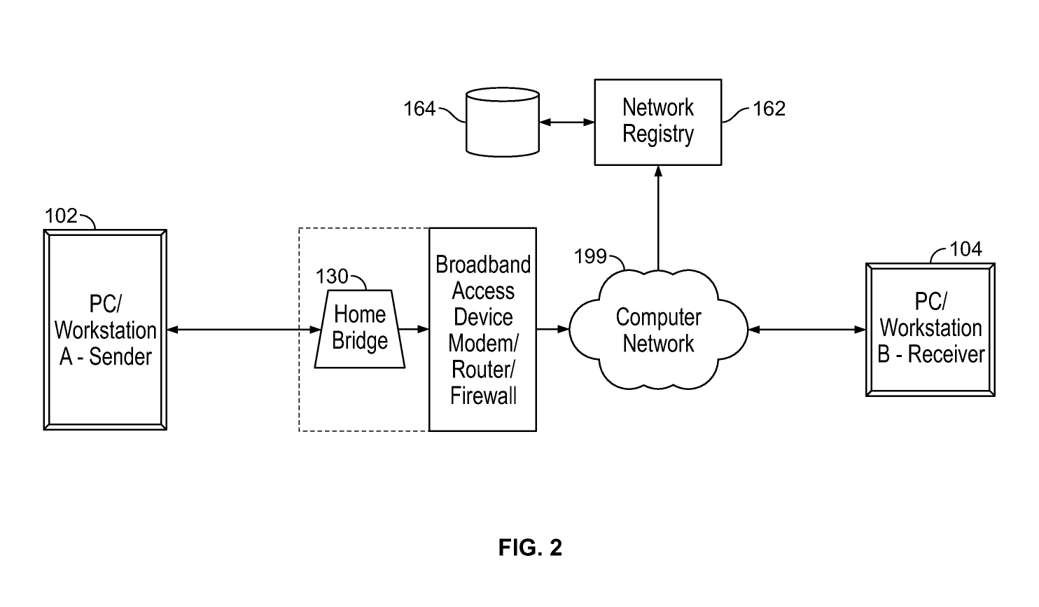

As shown in FIG. 2, the home bridge appliance 130 registers with the network registry 162. The home bridge appliance 130 can register itself with the network registry 162 by identifying its current IP address and all private email users with persistence at that address. As shown in FIG. 2, registration information flows from the home bridge appliance 130 through the computer network 199 to the network registry 162. The registration information for the home bridge appliance 130 can be stored in a registry database 164 on a computer-readable media that can be accessed by the network registry 162 to confirm authorization. Likewise, sending computer 102 can also provide registration information for home bridge appliance 130. The registration information provided to network registry 162 is updated when changes occur to the IP address information of the home bridge appliance 130. For example, when using dynamic IP addresses or when the list of private email users with persistence on the home bridge appliance 130 changes, the network registry 162 is updated with the new information.

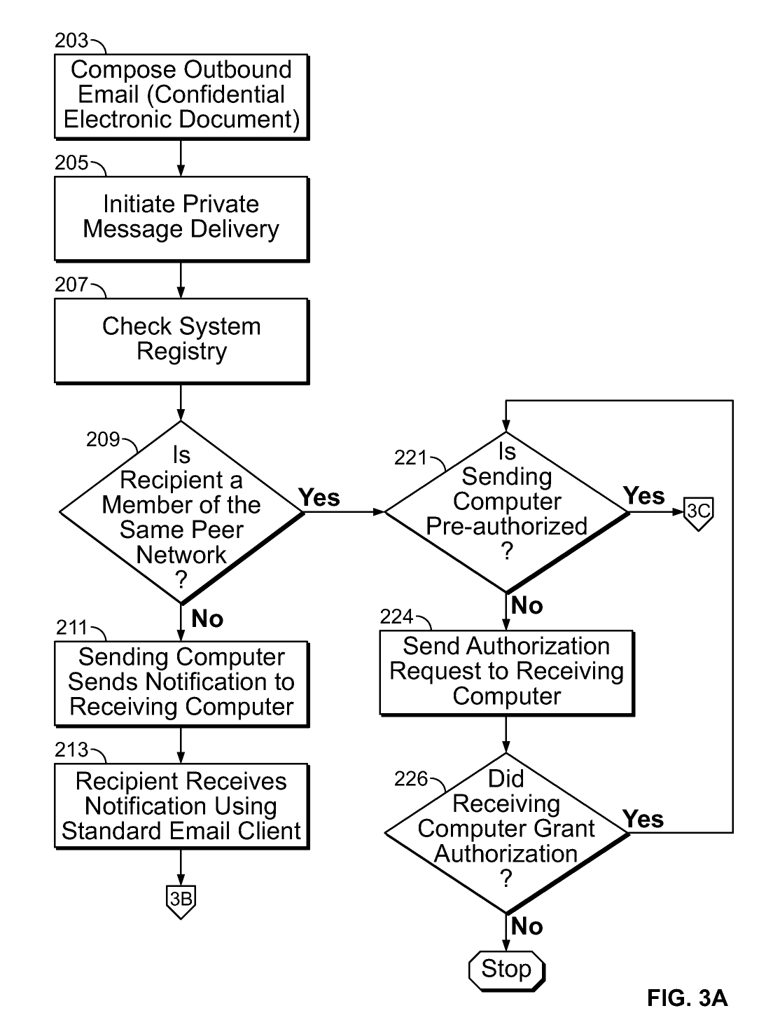

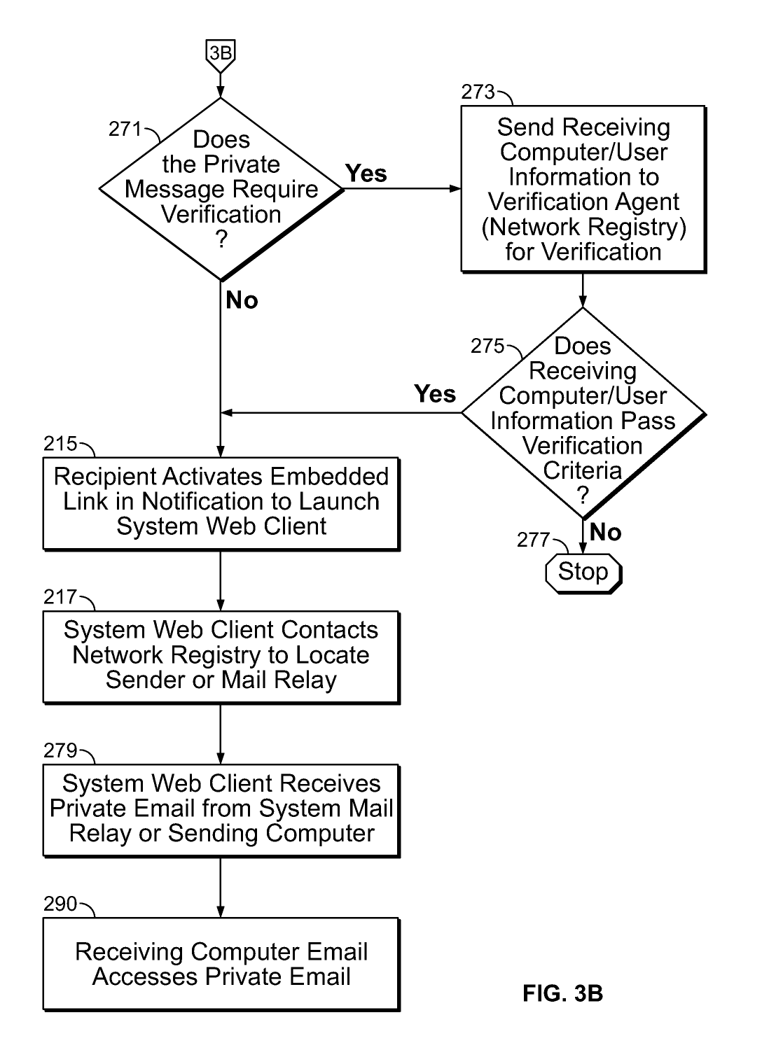

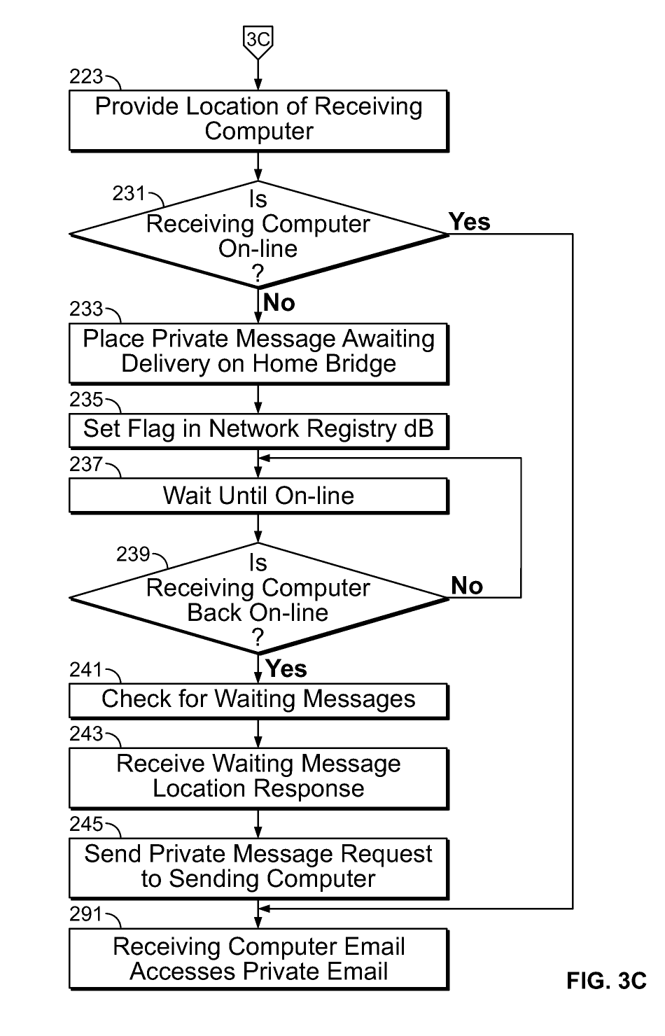

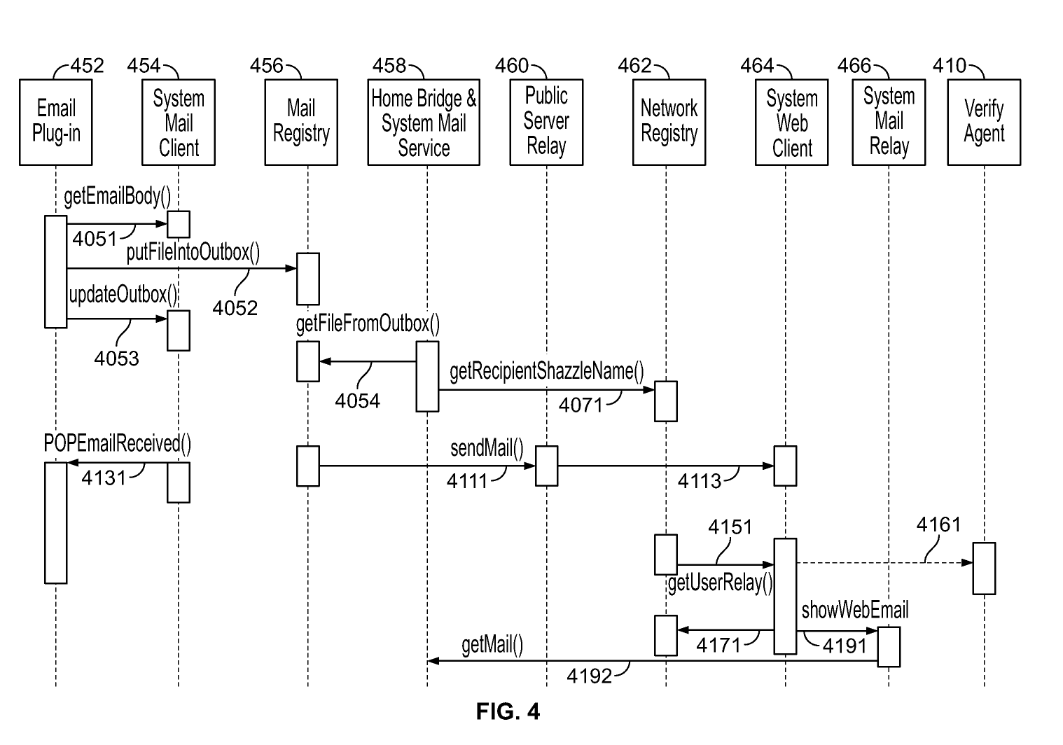

A process for delivering confidential electronic files using a computer system of FIG. 1 is illustrated in FIGS. 3A-3C. FIG. 4 can be used in conjunction with the flow chart of FIGS. 3A-3C to further understand the method and system of delivering confidential electronic documents in accordance with the claimed invention.

In block 203 of FIG. 3A (see also FIG. 4), the user of an email client on sending computer 102 uses email plug-in 452 of the claimed invention to compose a confidential electronic document, such as an outbound email message for delivery to receiving computer 104. In block 205 of FIG. 3A, the user indicates to sending computer 102 that a selected electronic document is to be delivered confidentially using the private message delivery methods and devices of the claimed invention. As further shown in FIG. 4, this initiation can include selecting a “Send Secure” option in block 4051 to initiate the confidential delivery of the electronic document where the email plug-in 452 acts upon the body of the email message. In block 4052, the email message is put into the outbox of the system mail client 454, and in block 4053, the outbox is updated. Once the outbox is updated, in block 4054 the system mail service 458, running on the user's sending computer 102, retrieves the secure email from the mail registry 456 and places the secure email on the home bridge appliance 458. Mail registry 456 can be a mailbox, inbox, outbox or other directory, folder, or storage location where email is stored before and/or after being sent.

The email plug-in 452 functionality can be added to the underlying email system of the user's sending computer 102 by installing computer readable instructions on a computer readable media (not shown separately) of the sending computer 102. As in the example above, the computer readable instructions can include plug-in functionality to add a “Send Secure” button to an email user interface screen on the sending computer 102 as well as the other functions and methods of the claimed invention. Of course, other techniques for adding this functionality can also be used.

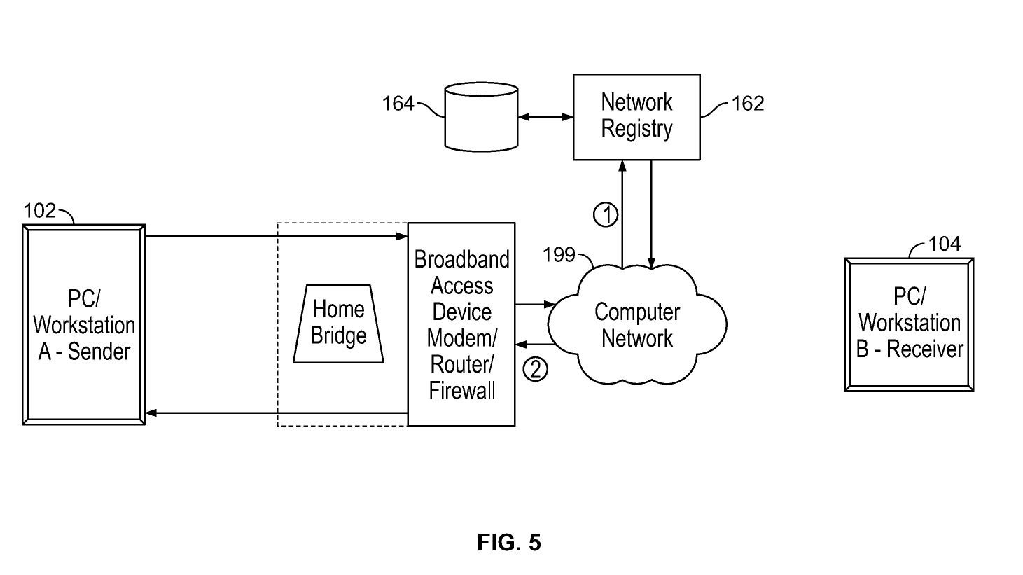

Returning to FIG. 3A, once the private message delivery is initiated and the secure email is retrieved from the outbound mail registry, in block 207 the home bridge appliance 458 checks the system registry 462 to determine if the message recipient on the receiving computer 104 is registered as a system member. The system and method of the claimed invention determines in block 209 of FIG. 3A whether the recipient is a member of the same peer network as the sender. That is, as further shown schematically in FIG. 5, the sending computer 102 checks the network registry 162 via computer network 199 to determine if the user at the receiving computer 104 is a member of the network registry stored in registry database 164. The location of the user at the receiving computer 104, for example, its IP address, is returned to the sending computer 102 if the user of the receiving computer 104 is a member of the network registry. If the user of the receiving computer 104 is not a member of the network registry 162, a “not found” message can be returned from the network registry 162 to the sending computer 102.

The network registry 162 checks to determine if both the sending computer 102 and the receiving computer 104 are members of the same peer network. When the sending computer 102 and the receiving computer 104 are members of the same private messaging network, they can track their network location and online status. For example, sending computer 102 and receiving computer 104 can track the network location and on-line status of the sending computer 102 and/or the receiving computer 104 at the time of transmission by using a presence monitoring tool in the home bridge appliance 130. The network registry check process to determine if both the sending computer 102 and the receiving computer 104 are members of the same peer network is also shown schematically in FIG. 4 as reference numeral 4071. If the network registry 162 determines in block 209 that the receiving computer 104 is registered as a member of the private message delivery system, the process continues to block 221 in FIG. 3A as described below.

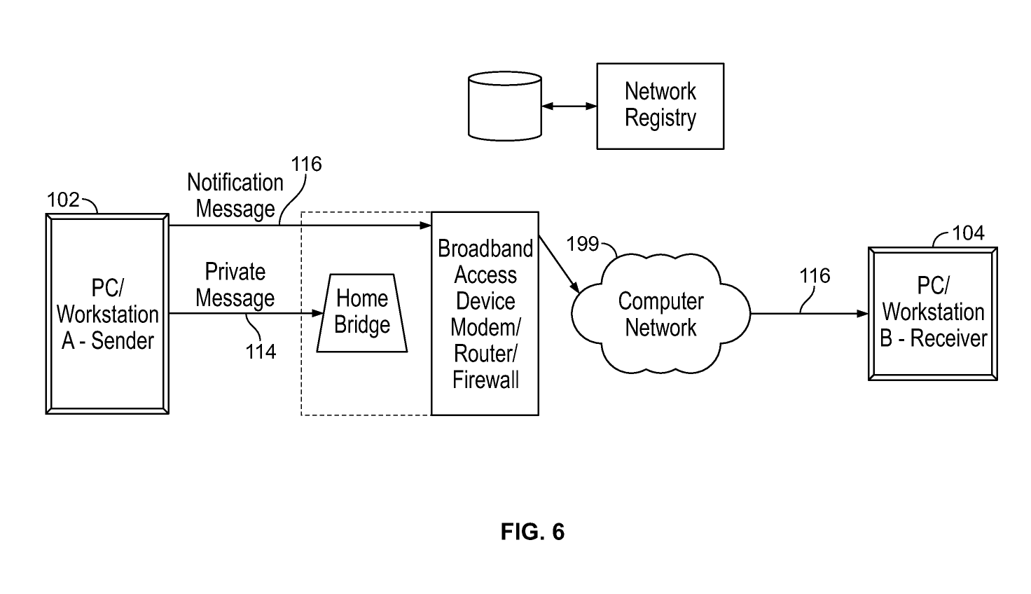

If, however, the network registry 162 determines in block 209 that the receiving computer 104 is not a registered member of the private message delivery system (that is, the user of the receiving computer 104 is not a member of the network registry 162), the process continues to block 211. As shown schematically in FIG. 6 and in block 211 of the process flow diagram of FIG. 3A, if the user of the receiving computer 104 is not a member of the network registry 162, the sending computer 102 can send a notification message 116 via computer network 199 to the user of the receiving computer 104 while placing the private message 114 on the home bridge appliance 130 to await delivery to the receiving computer 104. The notification message 116 can be sent to receiving computer 104 via a public server relay, such as shown further in FIG. 4, where the mail registry 456 of the sending computer 102 sends an email notification in block 4111 to the public server relay 460. The receiving computer 104 then retrieves the notification message 116 from the public server relay 460 at block 4113 (block 213 in FIG. 3A). The notification message 116 can be sent via SMTP email, SMS, or other public messaging protocol.

Once the notification is sent to the receiving computer 104, in block 4131 (block 213 in FIG. 3A) the receiving computer 104 receives a notification email using a standard email client from a standard, non-private email network, such as public server relay 460. The notification email includes an embedded link in the email message from the network registry 462. The user of the receiving computer 104 selects the link.

Upon selection of the link in block 213, the system and method of the claimed invention determines if the private message requires verification in block 271 of FIG. 3B. If the system and method of the claimed invention determines that the private message does not require verification, the process continues directly to block 215. If the system and method of the claimed invention determines that the private message requires verification, the process continues to block 273 as described below.

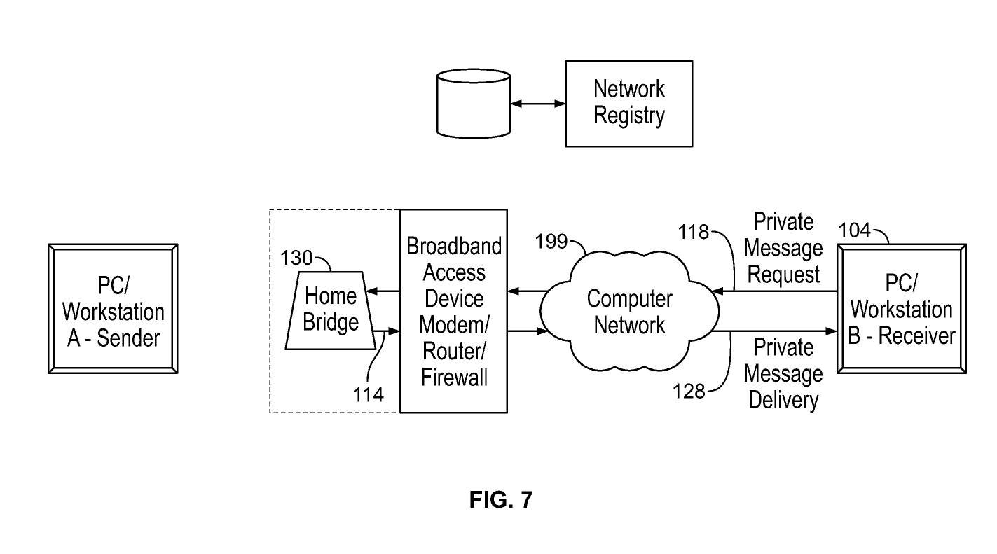

As also shown schematically in FIG. 7, when the user of receiving computer 104 activates the embedded link in the email message, the activation serves as a private message request 118 in block 215 of FIG. 3B. As further shown in FIG. 4, activating the link in the notification email launches the system web client 464 in block 4151 that enables a user to traverse information resources on the computer network 199. As also shown in block 217 of FIG. 3B, the system web client 464 contacts the network registry 462 to locate the home bridge 130 that has the private email. For example, in FIG. 4, the system web client 464 contacts the network registry 462 in block 4171 by sending a getUserRelay( ) process to locate the home bridge 130 that contains the private email. As shown in FIG. 7, once located, the home bridge 130 performs a private message delivery 128 to deliver private message 114 to the receiving computer 104 via computer network 199 (block 290 in FIG. 3B).

Alternatively, when the system web client 464 contacts the system registry 462, the system registry 462 can provide an indication that the private message requires verification as determined in block 271 in FIG. 3B. For example, when a direct connection between the would-be receiving computer and the home bridge of the sending computer cannot be established, verification of the private message can be required.

In this instance, in order to send the message directly between the sending computer 102 and a receiving computer 104, a signaling mechanism, such as signaling mechanism from network registry 462 is used to notify the recipient that a message is waiting for him. A third party agent, such as verification agent 410 is used to verify the recipient's identity with an authentication protocol specified by the sender. If it is determined above that verification is required in block 271, the process continues to block 273 where receiving computer information is sent to the verification agent, such as network registry 162, for authentication/verification. Additionally, user information (that is, information regarding the user(s) of the receiving computer) is also sent to the verification agent, such as network registry 162, for authentication/verification of the user, as a receiving computer can be used by multiple users. Additionally, the sending computer 102 can also act as a verification agent and provide verification criteria with which the receiving computer must comply. The network registry 162 or other verification agent determines in block 275 whether the receiving computer information passes the verification criteria. If the receiving computer information does not pass the verification criteria, the process stops. A “verification failure” or other message can be sent to alert the sending and receiving computers that activation of the link was unsuccessful. If, however, the receiving computer information passes the verification criteria in block 275, the process continues to block 215 whereby activation of the embedded link launches the system web client. This process is shown further in FIG. 4 in block 4161 where the system web client 464 queries verification agent 410. As outlined above, verification criteria could include a host of receiving computer information, including a password identification, a user ID, a certificate, and the like.

In block 275, the system determines if the receiving computer information passes the verification criteria. If the receiving computer information does not pass the verification criteria, the process stops in block 277. If, however, the receiving computer information passes the verification criteria, the process continues to block 215. Likewise, if the system determined in block 271 that verification of the private message was not required (for example, if a direct connection between the would-be receiving computer and the sending computer can be established), the process proceeds directly to block 279.

Once authenticated, in block 215, the receiver activates an embedded link in the notification message to launch a system web client, and the verification agent 110 confirms that location information and access instructions are available for the receiving computer 104 to receive the private message. After the verification agent 110 verifies the authenticity of the recipient, it provides access instructions that allow the recipient to locate a dynamic sender in block 217, where the system web client contacts the network registry 162 (verification agent) to locate the sender or mail relay. These access instructions and link provide additional resilience patterns to increase reliability of the direct transfer because the sender is able to send from dynamic locations. Because the message itself is not stored at the verification agent 110 (only the location of the message) the contents of the message remain completely private. In addition, because the identify verification protocol may be specified by the sender, the third party verification agent 110 does not know who the recipient is—only that the recipient has passed an identity test devised by the sender. Also, the third party verification agent 110 will never know what content passes between sender and receiver.

After the system web client contacts the network registry 162 to locate the sender or mail relay in block 217, in block 279 of FIG. 3B, the system web client receives the private email from the home bridge 130 of the sending computer 102 or the system mail relay 466, and the email client of the receiving computer 104 accesses the private email in block 290 of FIG. 3B. For example, in FIG. 4, the system web client 464 sends a showWebEmail( ) process to system mail relay 466 in block 4191 receives the private email from the system mail relay 466 by executing a getMail( ) process in block 4192, and the email client of the receiving computer 104 accesses the private email. When the receiving computer 104 receives the private email message, the message can be stored in a destination email box to be subsequently viewed using an email client, email reader, mail user agent, and the like.

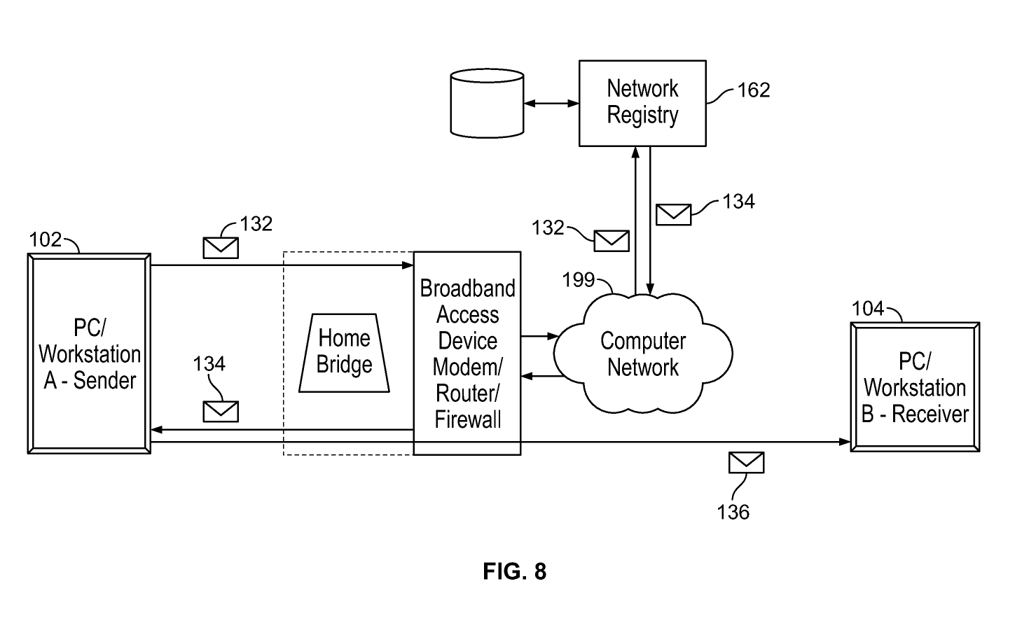

Returning to block 209 of FIG. 3A, if the system determines that the receiving computer 104 of the recipient is also a member of the mail service peer network (along with the sending computer), the process continues to block 221. The process is shown further in FIG. 8 where sending computer 102 checks the network registry 162 using a check registry message 132 to determine if the receiving computer 104 is a member of the peer network. If the receiving computer 104 is a member of the registry 162, the network registry 162 checks sending computer 102 to determine if the sending computer 102 is authorized to send messages to the receiving computer 104. When the network registry 162, in block 221, determines that receiving computer 104 is a member of the network registry 162 and the sending computer 102 is pre-authorized to send a private message to the receiving computer 104, the location of the receiving computer 104 is provided in block 223 to the sending computer 102 using a location message 134. If the sending computer 102 is not pre-authorized to send a private message to the receiving computer 104, the sending computer 102 sends an authorization request message 136 in block 224 to the receiving computer 104 seeking authority to send private messages to the receiving computer 104. If the receiving computer 104 grants authorization to sending computer 102 in block 226, it provides the sending computer 102 with the location of the receiving computer in block 223.

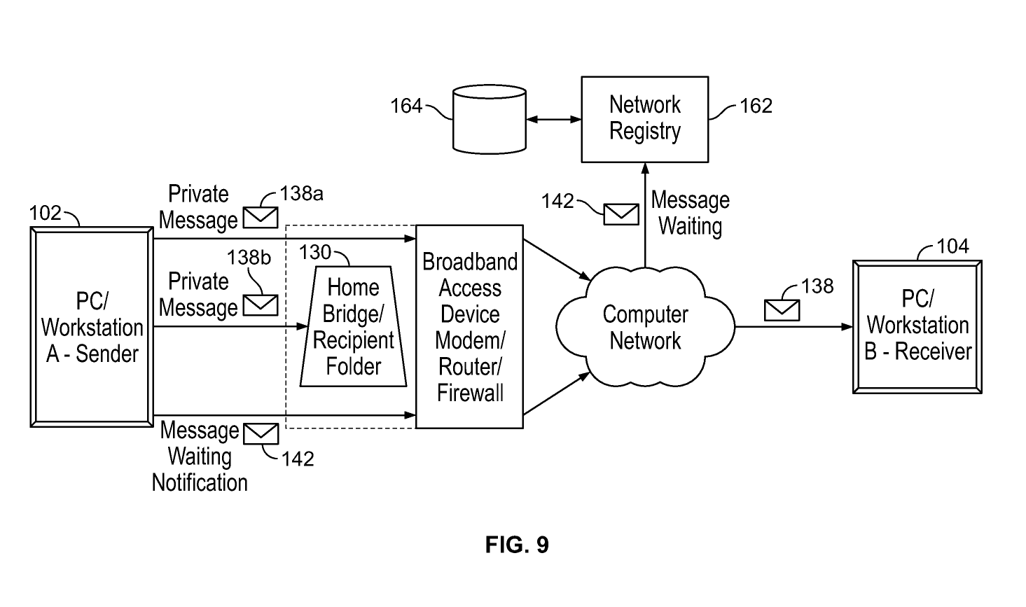

The process of sending and receiving email with both the sending computer and the receiving computer registered with the network registry is further illustrated in conjunction with FIG. 4. In block 231 of FIG. 3C, the system determines if the receiving computer 104 is on-line and connected to the peer network. For example, as shown in block 4311 of FIG. 4, the home bridge system mail service 458 sends a getRecipientShazzleName( ) process to the network registry 462. If the receiving computer 104 is on-line, the process continues to block 291 of FIG. 3 and the private message being sent 138a is pushed to the receiving computer 104 as shown further in FIG. 9.

If the receiving computer 104 is not on-line in block 231, the system will wait to deliver the confidential electronic document (private message 138) until the receiving computer 104 is back on-line as shown in block 237 of FIG. 3C before proceeding to block 232. In the mean time, as shown also in FIG. 9, when the receiving computer 104 is off line, the private message 138b is placed on the home bridge 130 to await delivery to the receiving computer 104 (shown also in block 233 in FIG. 3). The private message awaiting delivery 138b can be placed in a folder on the home bridge 130 designated for that recipient on receiving computer 104. The sending computer 102 sends a message waiting notification 142 to the network registry 162, and a flag is set in a database 164 of the network registry 162 to provide notice to the receiving computer 104 that a message is awaiting (shown also in block 235 in FIG. 3C). The message waiting flag can have the sender's name or other identification related to the sending computer 102 so the receiving computer 104 can identify the sender.

Conventional store and forward telecommunications techniques store the electronic communication at an intermediate station, such as an email server or the like, and send the communication to the receiving computer at a later time. In the systems of the claimed invention, a high degree of privacy is achieved by maintaining physical possession of the electronic communication strictly with the home bridge and the receiver. No copies of the e-mail message or attachment(s) are persisted with outside parties, including intermediate stations. As such, there is no opportunity to intercept the confidential electronic communication by breaching the intermediate station.

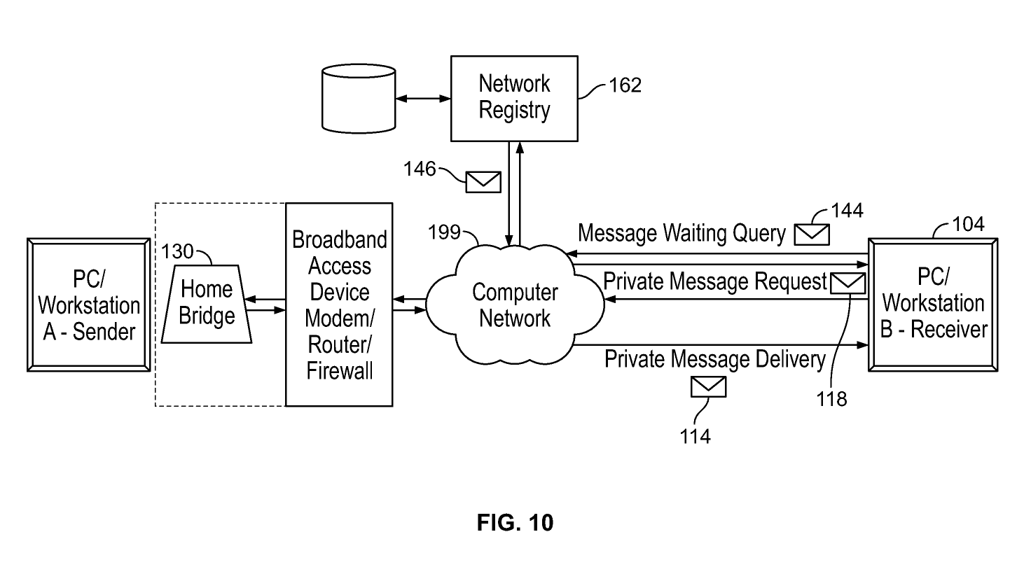

When the receiving computer 104 is back on-line in block 239 of FIG. 3C, the process continues to block 241 where the receiving computer 104 checks for waiting messages by sending a message waiting query 144 to the network registry 162 as further shown in FIG. 10.

For additional security and reliability in sending the message directly between a home bridge of the sending computer 102 and a receiving computer 104, a signaling mechanism can be used to notify the recipient on the receiving computer 104 that a message is waiting for him. The network registry 162 can be used to verify the recipient's identity with a protocol specified by the sender, and the network registry 162 can then pass the location information and access instructions needed to receive the private message to the receiving computer 104. This provides additional resilience patterns to increase reliability of the direct transfer because the sender is able to send from dynamic locations utilizing the home bridge 130. Because the message itself is not stored at the network registry 162 (only the location of the message) the contents of the message remain completely private.

For example, in block 243, the network registry 162 responds by providing a waiting message location response 146 with the location of the home bridge 130. The receiving computer 104 then sends a private message request 118 via computer network 199 to the home bridge 130 in block 245 and receives the private message 114 from the home bridge 130 in block 291 of FIG. 3C.

Delivering Confidential IM Messages

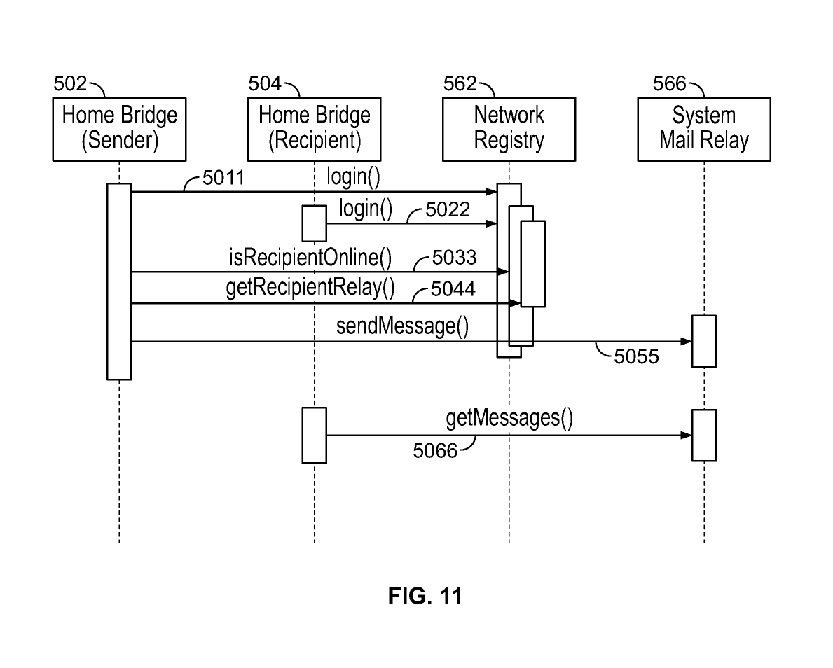

FIG. 11 shows an example method for delivering confidential instant messages (IM) to a receiving computer using a browser application in a system of the claimed invention. In this example, a user does not need to install an email plug-in or an IM plug-in and can use a browser to send and receive secure IMs via a home bridge device. For example, a user on a sending computer 102 that wants to send a private IM uses the home bridge 502 of sending computer 102 to open a web based private email page in block 5011. A login or other verification can be used to pass credentials to the network registry 562 to confirm that both the sender and recipient are peer network members.

In block 5022, the sender's web based private IM page authenticates to the network registry 562. For example, the sending computer 102 can send a login( ) process to the network registry 562 to be authenticated. By providing authentication to the sending computer 102, the network registry 562 confirms that the user of the sending computer 102 is a registered user and is in compliance with any qualifications for using the system of the claimed invention.

In block 5033 the sender's web based private IM page notifies the network registry 562 that the sending computer 102 is on line. For example, the sending computer 102 can send a isRecipientOnline( )process to the network registry 562 to provide notification. In block 5044 the sender's web based private IM page uses the home bridge 502 of the sending computer 102 and receives the location of the system mail relay 566 of the receiver of the IM from the network registry 562. For example, the home bridge browser polls the relay and then receives the information from the relay. Once the home bridge 502 of the sending computer 102 has the location of the system mail relay 566 of the receiving computer 104, the home bridge 502 of the sending computer 102 then sends the private IM to the system mail relay 566 of the receiving computer 104 in block 5055. For example, the sending computer 102 can send a isRecipientOnline( ) process to the network registry 562 to provide notification. Once the system mail relay 566 receives the private IM from the home bridge 502 of the sending computer 102, the system mail relay 566 relays the IM to the home bridge 504 of the receiving computer 104 in block 5066, and the web based private IM page of the receiving computer 104 receives the private message.

Remote Browsing of Mailboxes on the Home Bridge

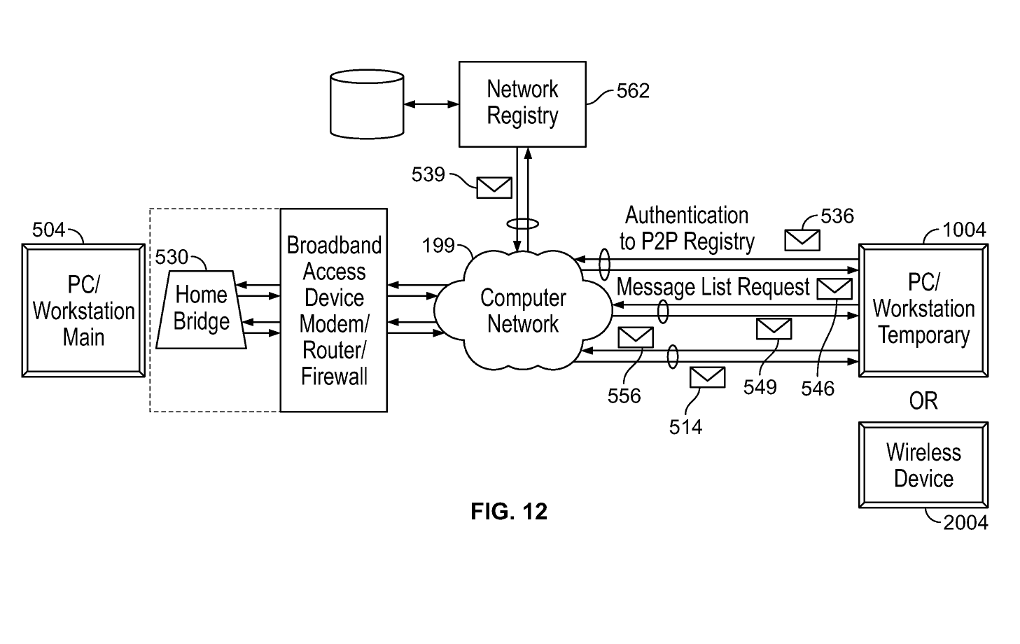

FIG. 12 shows an example system and method for accessing confidential electronic documents, including private email messages, using remote mail access. Often, users want to retrieve a confidential electronic document, and they do not have access to their home computer or computing device in which a plug-in application in accordance with the claimed invention is installed. A user wants to access his email from any computer. The home bridge 130 provides the flexibility and accessibility that users desire while providing a truly secure email delivery process.

In the example of FIG. 12, a user can securely send and receive electronic documents from a remote computing device. For example, a user who normally sends and receives electronic documents on their computer 504 that is connected to the user's home bridge 530 would like to access their electronic mail box remotely. That is, the user would like to access their electronic mail box using a temporary computer 1004 or a wireless device, such as wireless device 2004.

When a P2P network mail user wishes to access his mail box(es) remotely, the user sends an authentication request 536 to the network registry 562 via computer network 199. The network registry 562 confirms that the user is registered and supplies the user at the temporary computer 1004 with a location message 539 providing the current location of the user's home bridge 530. The user then sends a message list request 546 to the home bridge 530. The home bridge 530 then provides the message list 549 to the user at the temporary computer 1004. The user at the temporary computer can then select a message to read by sending a request details message 556 to the home bridge 530, and the home bridge 530 can then provide the details of the private message 514 to the user at the temporary computer 1004. This allows a user to browse messages from their mailbox, including already-read and not-yet-read messages residing on the home bridge 530.

Sending a Message to a Receiver Behind a Firewall (SMS Not Supported)

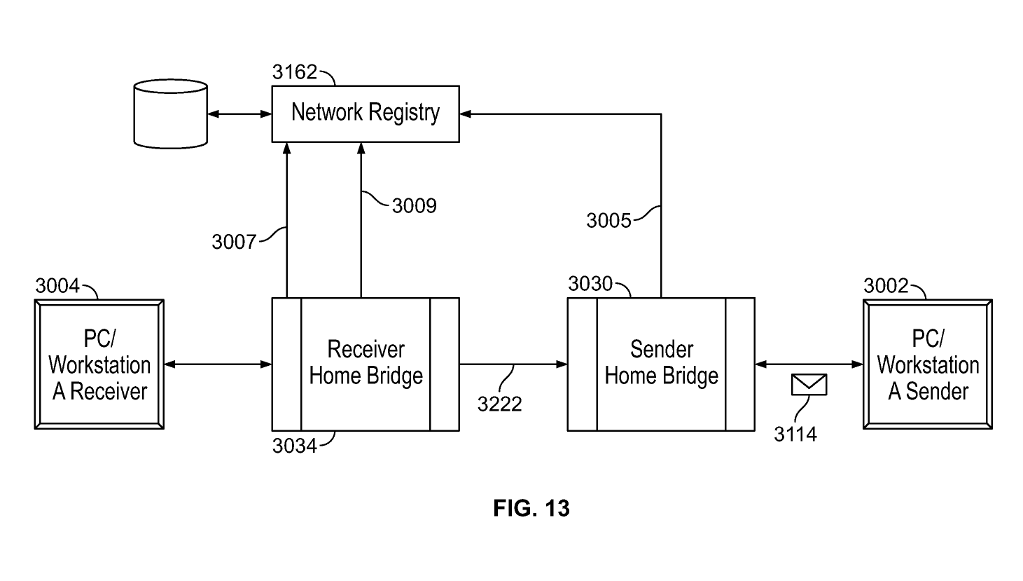

When a mail sender is unable to send a private message directly due to network address translation (NAT) constraints and/or firewall constraints of the receiving computer, the user can send the private message based upon a process illustrated in FIG. 13. For example, some networks modify IP address information in IP packet headers while in transit across a routing device, while other networks impose constraints on the address translation. FIG. 13 illustrates a scenario where the receiving computer 3004 is behind a firewall, and Short Message Service (SMS) text messaging communication is not supported. As shown in FIG. 13, when a user on sending computer 3002 is unable to send a private message directly, the sending computer 3002 provides the private message 3114 to the sending computer home bridge 3030. The sending computer home bridge 3030 sets a message wait flag 3005 with the network registry 3162. The message wait flag 3005 includes a sender home bridge address that corresponds to the IP address of the sending computer home bridge 3030. The receiving computer home bridge 3334 periodically checks 3007 the network registry 3162 to determine if any message wait flag 3005 has been set that would indicate a sending computer 3002 would like to deliver a private message to the receiving computer 3004. When the receiving computer home bridge 3034 finds that a message wait flag 3005 is set, the receiving computer home bridge 3334 uses the IP address of the sending computer home bridge from the message wait flag 3005 to determine the proper sending computer home bridge 3030 has a message waiting to be delivered. The receiving computer home bridge 334 then retrieves the private message from the sending computer home bridge in block 3222. Once the private message is retrieved, the receiving computer home bridge 3034 uses a remove message wait flag 3009 to remove the message wait flag 3005 from the network registry 3162.

Sending a Message to a Receiver (SMS Supported)

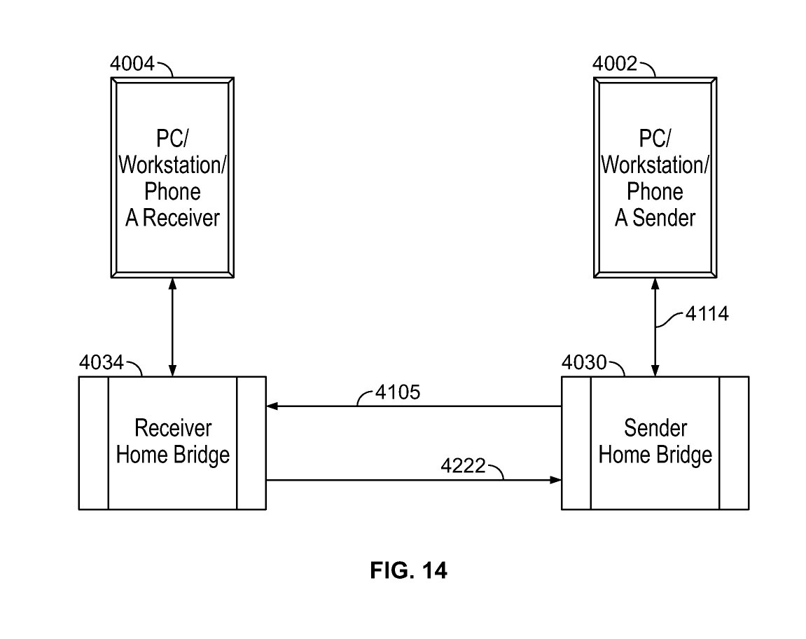

FIG. 14 shows a scenario when a mail sender is unable to send a private message directly due to network address translation (NAT) constraints and/or firewall constraints of the receiving computer similar to the scenario described above with regard to FIG. 13. However, in the scenario of FIG. 14, the receiving computer 4004 is behind a firewall, but Short Message Service (SMS) text messaging communication is supported. As shown in FIG. 14, when a user on sending computer 4002 is unable to send a private message directly, the sending computer 4002 provides the private message 4114 to the sending computer home bridge 4030. The sending computer home bridge 4030 sends an SMS message 4105 to the receiving computer home bridge 4034. The SMS message 4105 includes a sender home bridge address that corresponds to the IP address of the sending computer home bridge 4030. No involvement by a network registry is required. The receiving computer home bridge 4034 receives the SMS message 4105, identifies the sender home bridge address and uses the IP address of the sending computer home bridge from the SMS message 4105 to determine the proper sending computer home bridge 4030 that has a message waiting to be delivered. The receiving computer home bridge 4034 then retrieves the private message from the sending computer home bridge in block 4222.

Receiver and Sender Behind Firewalls (SMS Not Supported)

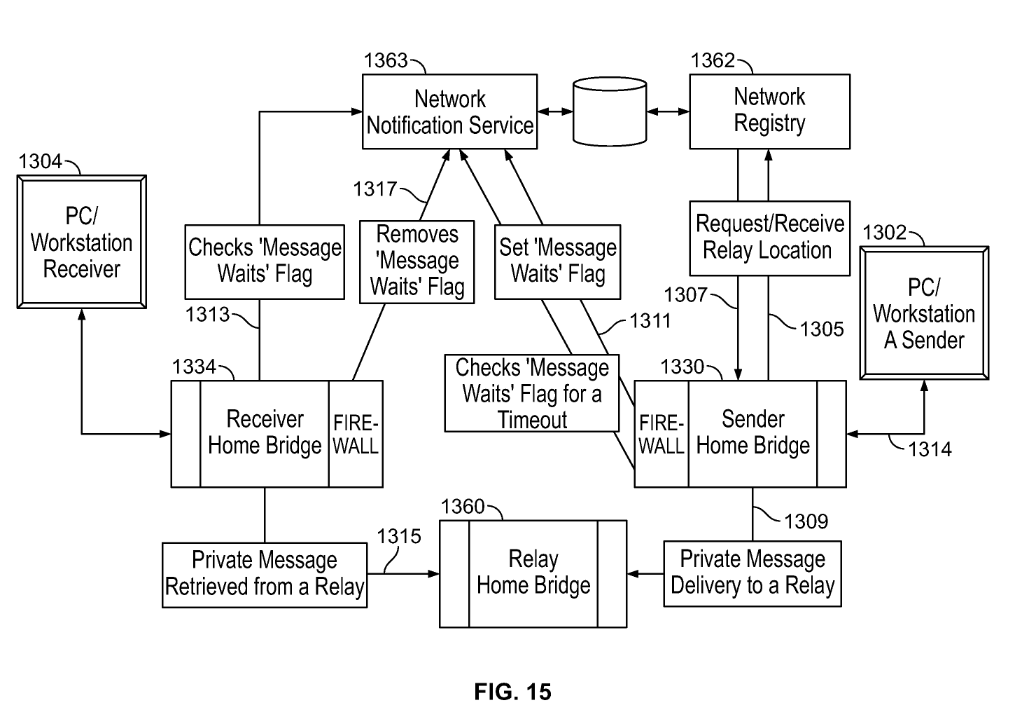

When a mail sender is unable to send a private message directly due to network address translation (NAT) constraints and/or firewall constraints of the sending computer and/or the receiving computer, the user can send the private message based upon a process illustrated in FIG. 15. As outlined above, some computer networks modify IP address information in IP packet headers while in transit across a routing device, while other networks impose constraints on the address translation. FIG. 15 illustrates a scenario where the sending computer 1302 and receiving computer 1304 are behind a firewall, and Short Message Service (SMS) text messaging communication is not supported. As shown in FIG. 15, a relay home bridge 1360 can be used to effect the delivery of the private message. For example, when a user on sending computer 1302 is unable to send a private message directly, the sending computer 1302 provides the private message 1314 to the sending computer home bridge 1330. The sending computer home bridge 1330 sends a relay message request 1305 to the network registry 1362. The network registry 1362 can function as a central relay registry and can assign a relay home bridge to facilitate delivery of the private message. As shown in FIG. 15, the network registry provides a relay location 1307 to the sending computer home bridge 1330, and the sending computer home bridge 1330 delivers the private message to the relay home bridge 1360 in block 1309.

The sending computer home bridge 1330 sets a relay message wait flag 1311 on a network notification service 1363. The network notification service 1363 can be a part of the network registry 1362 or can be a separate physical or virtual computer device. For clarity and brevity, network notification service 1363 is shown as a separate device in FIG. 15. The relay message wait flag 1311 includes a relay home bridge address that corresponds to the IP address of the relay computer home bridge 1360.

The receiving computer home bridge 1334 periodically checks 1313 the network notification service 1363 to determine if any (relay) message wait flag 1311 has been set that would indicate a sending computer 1302 would like to deliver a private message to the receiving computer 1304. When the receiving computer home bridge 1334 finds that a (relay) message wait flag 1311 is set, the receiving computer home bridge 1334 uses the IP address of the relay home bridge 1360 from the (relay) message wait flag 1311 to determine the proper relay home bridge 1360 that has a message waiting to be delivered. The receiving computer home bridge 1334 then retrieves the private message from the relay computer home bridge 1360 in block 1315. Once the private message is retrieved, the receiving computer home bridge 1334 uses a remove (relay) message wait flag 1317 to remove the (relay) message wait flag 1311 from the network notification service 1363.

Sending computer home bridge 1330 periodically checks for a time out of the (relay) message wait flag 1311. If the private message is not delivered—that is, if the (relay) message wait flag 1311 is not removed within the time out period, the process can be repeated from the start.

Receiver and Sender Behind Firewall (SMS Not Supported—Streaming Relay)

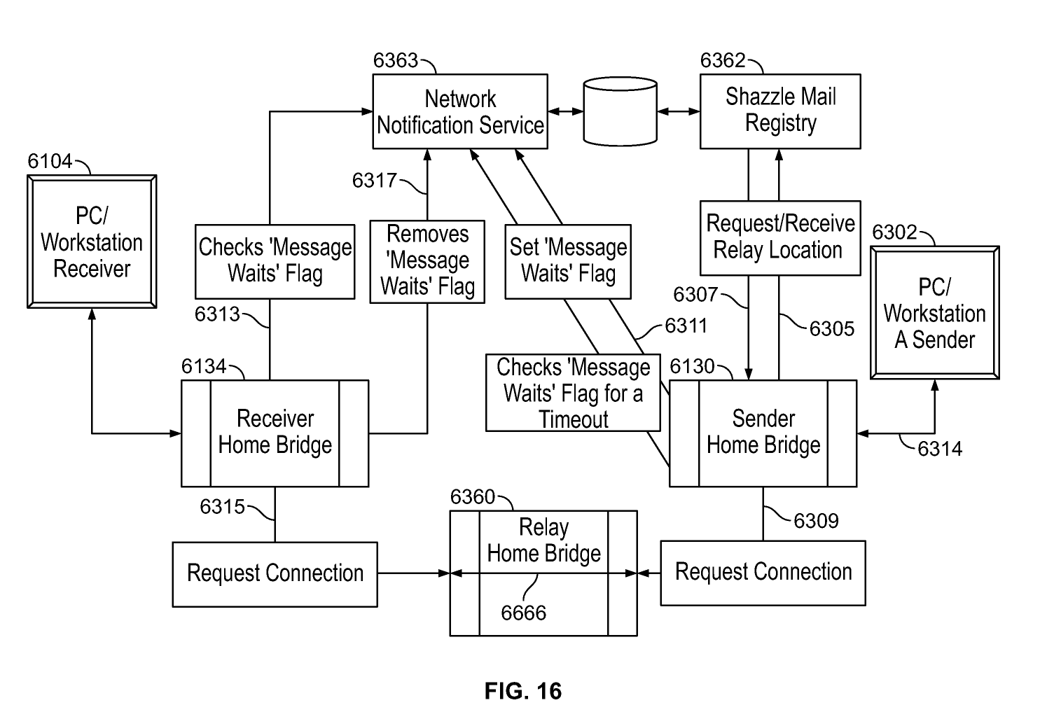

As in the cases above, when a mail sender is unable to send a private message directly due to network address translation (NAT) constraints and/or firewall constraints of the sending computer and/or the receiving computer, the user can send the private message based upon a process illustrated in FIG. 16. As outlined above, some computer networks modify IP address information in IP packet headers while in transit across a routing device, while other networks impose constraints on the address translation. FIG. 16 illustrates a scenario where the sending computer 6302 and receiving computer 6304 are behind a firewall, and Short Message Service (SMS) text messaging communication is not supported. As shown in FIG. 16, a relay home bridge 6360 can be used to effect the delivery of the private message by streaming the private message to the relay home bridge 6360 and streaming the delivery of the private message to the receiving computer home bridge 6314. For example, when a user on sending computer 6302 is unable to send a private message directly, the sending computer 6302 provides the private message 6314 to the sending computer home bridge 6130. The sending computer home bridge 6130 sends a relay message request 6305 to the network registry 6362. The network registry provides a relay location 6307 to the sending computer home bridge 6130.

The sending computer home bridge 6130 sets a relay message wait flag 6311 on a network notification service 6363. As above, the network notification service 6363 can be a part of the network registry 6362 or can be a separate physical or virtual computer device. For clarity and brevity, network notification service 6363 is shown as a separate device in FIG. 16. The relay message wait flag 6311 includes a relay home bridge address that corresponds to the IP address of the relay computer home bridge 6160. The sending computer home bridge 6130 requests a connection on the relay home bridge 6160 in block 6309.

The receiving computer home bridge 6134 periodically checks 6313 the network notification service 6363 to determine if any (relay) message wait flag 6311 has been set that would indicate a sending computer 6302 would like to deliver a private message to the receiving computer 6304. When the receiving computer home bridge 6134 finds that a (relay) message wait flag 6311 has been set, the receiving computer home bridge 6134 uses the IP address of the relay home bridge 6160 from the (relay) message wait flag 6311 and requests a connection to relay home bridge 6160 at block 6315. When a connection is established, the sending computer home bridge 6130 sends the message to the receiving computer home bridge 6134 via relay home bridge 6160 at block 6666.

Once the private message is received, the receiving computer home bridge 6134 uses a remove (relay) message wait flag 6317 to remove the (relay) message wait flag 6311 from the network notification service 6363.

Sending computer home bridge 6130 periodically checks for a time out of the (relay) message wait flag 6311. If the private message is not delivered—that is, if the (relay) message wait flag 6311 is not removed by the receiver home bridge 6134 within the time out period, the process can be repeated from the start.

Receiver and Sender Behind Firewall (SMS Supported—Relay as Mail Box)

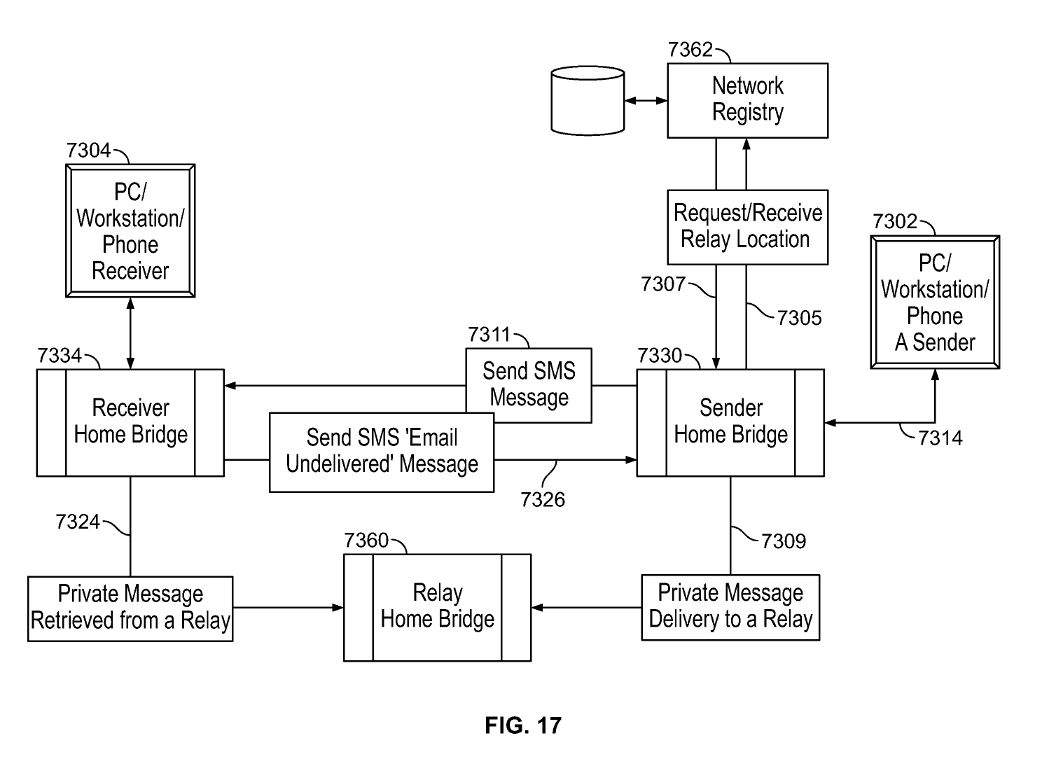

As in the cases above, when a mail sender is unable to send a private message directly due to network address translation (NAT) constraints and/or firewall constraints of the sending computer and/or the receiving computer, the user can send the private message based upon a process illustrated in FIG. 17. As indicated above, some computer networks modify IP address information in IP packet headers while in transit across a routing device, while other networks impose constraints on the address translation. FIG. 17 illustrates a scenario where the sending computer 7302 and receiving computer 7304 are behind firewalls, but Short Message Service (SMS) text messaging communication is supported. As shown in FIG. 17, a relay home bridge 7360 can be used to effect the delivery of the private message by providing the private message to the relay home bridge 7360, apprising the receiving home bridge 7334 that a private message is waiting, and then delivering the private message to the receiving computer home bridge 6314 via the relay home bridge 7360. For example, when a user on sending computer 7302 is unable to send a private message directly, the sending computer 7302 provides the private message 7314 to the sending computer home bridge 7330. The sending computer home bridge 7330 sends a relay message request 7305 to the network registry 7362. The network registry provides a relay location 7307 to the sending computer home bridge 7330, and the sending computer home bridge 7330 delivers the private message to the relay home bridge 7360 in block 7309.

The sending computer home bridge 7330 sends an SMS message 7311 with the address of the relay home bridge 7360 to the receiving computer home bridge 7334. Using the address, the receiving computer home bridge 7334 retrieves the private message 7324 from the relay home bridge 7360.

If, for some reason, the receiving computer home bridge 7334 is unable to retrieve the private message from the relay home bridge 7360, in block 7326 the receiving computer home bridge 7334 will send an SMS message back to the sending computer home bridge 7330 indicating that the private message was not delivered. The SMS message can be an “email undelivered” message or the like. If the sending computer home bridge 7330 receives such a message, the process can be repeated from the start.

Receiver and Sender Behind Firewall (SMS Supported—Streaming Relay)

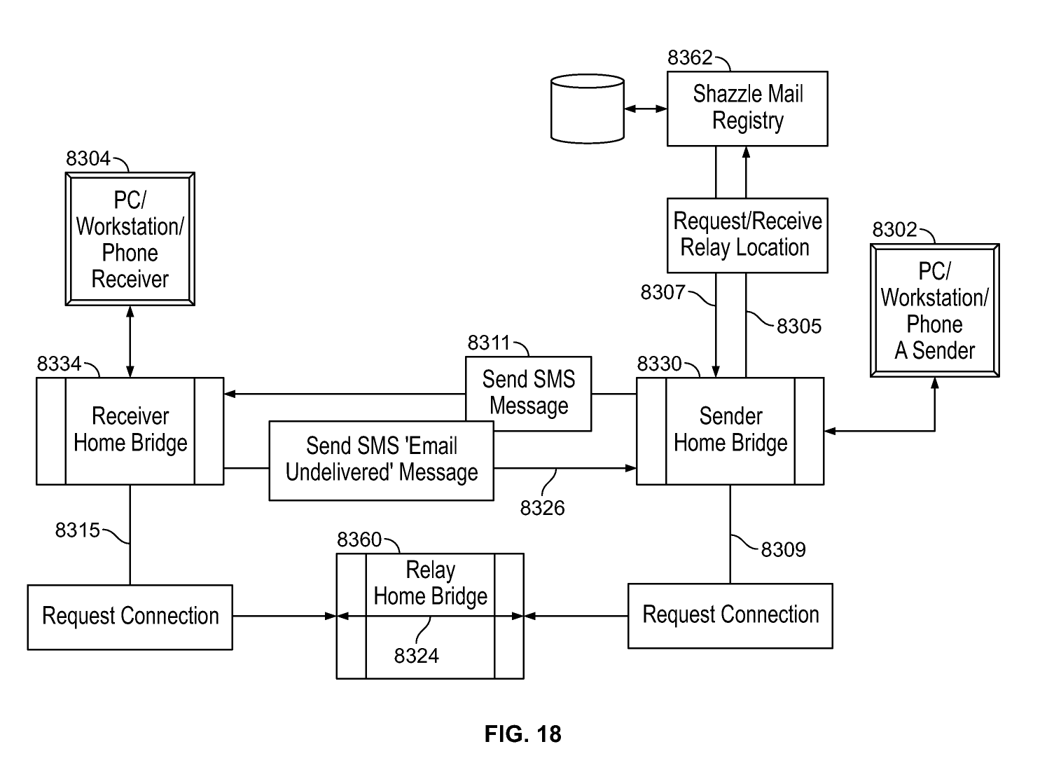

As in the cases above, when a mail sender is unable to send a private message directly due to network address translation (NAT) constraints and/or firewall constraints of the sending computer and/or the receiving computer, the user can send the private message based upon a process illustrated in FIG. 18. As indicated above, some computer networks modify IP address information in IP packet headers while in transit across a routing device, while other networks impose constraints on the address translation. FIG. 18 illustrates a scenario where the sending computer 8302 and receiving computer 8304 are behind firewalls, but Short Message Service (SMS) text messaging communication is supported. As shown in FIG. 18, a relay home bridge 8360 can be used to effect the delivery of the private message by streaming the private message to the relay home bridge 8360 and streaming the delivery of the private message to the receiving computer home bridge 8334.

For example, when a user on sending computer 8302 is unable to send a private message directly, the sending computer 8302 provides the private message 8314 to the sending computer home bridge 8330. The sending computer home bridge 8330 sends a relay message request 8305 to the network registry 8362. The network registry provides a relay location 8307 to the sending computer home bridge 8330. The sending computer home bridge 8330 requests a connection on the relay home bridge 8360 in block 8309.

The sending computer home bridge 8330 sends an SMS message 8311 with the address of the relay home bridge 8360 to the receiving computer home bridge 8334. Using the address, the receiving computer home bridge 8334 requests a connection with relay home bridge 8360 in block 8315. A connection is established, and the receiving computer home bridge 8334 retrieves the private message 8324 from the relay home bridge 8360.

If, for some reason, the receiving computer home bridge 8334 is unable to retrieve the private message from the relay home bridge 8360, in block 8326 the receiving computer home bridge 8334 will send an SMS message back to the sending computer home bridge 8330 indicating that the private message was not delivered. The SMS message can be an “email undelivered” message or the like. If the sending computer home bridge 8330 receives such a message, the process can be repeated from the start.

Smart Phone Usage

As outlined above, the systems and methods of the claimed invention for sending confidential electronic messages over a computer network can also include the use of mobile and portable computing devices, including smart phones and other devices that can access data over Wi-Fi and cellular networks. These mobile computing devices can include wireless access to a public network such as the Internet and can serve as standalone home bridge devices and/or function as relays to provide home bridge functionality for other mobile computing devices.

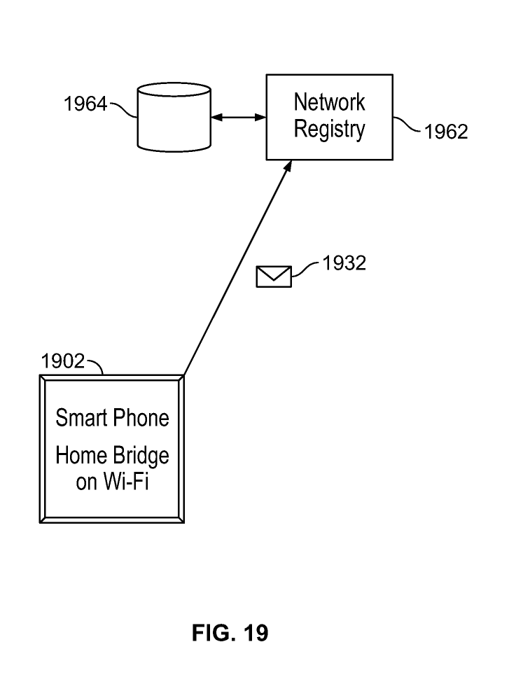

For example, as was the case with registration of the home bridge device in FIG. 2, in FIG. 19, a smart phone 1902 can register as a home bridge appliance with the network registry 1962 by providing its current IP address 1932. With wireless access and addressability, smart phone 1902 can function as a home bridge relay to other computing devices as well. The registration information for the smart phone 1902 to function as a home bridge appliance can be stored in a registry database 1964 on a computer-readable media that can be accessed by the network registry 1962 to confirm authorization. The registration information provided to network registry 1962 is updated when changes occur to the IP address information of the smart phone 1902 (with home bridge functionality). For example, when using dynamic IP addresses or when the list of private email users with persistence on the smart phone 1902 changes, the network registry 1962 is updated with the new information.

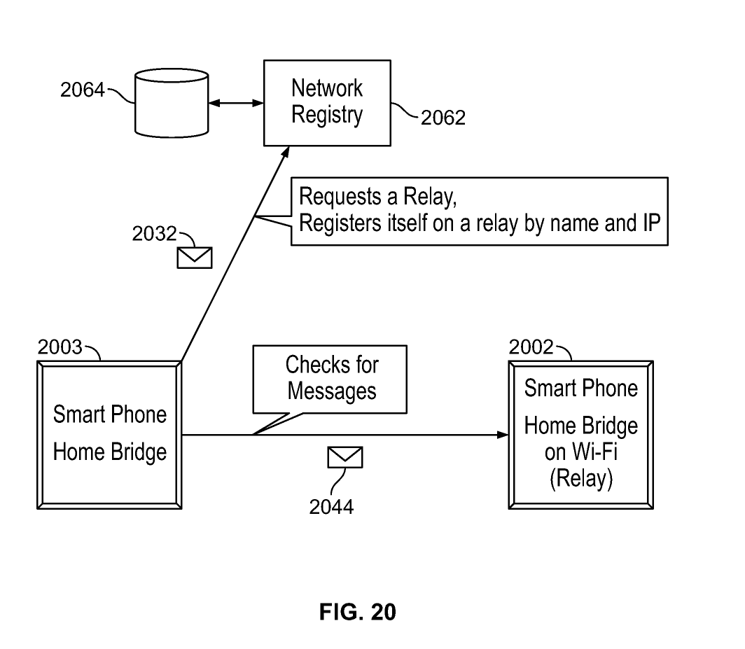

As shown in FIG. 20, the addressable smart phone 2002 on the wireless network (Wi-Fi, Bluetooth, GPS, and the like, for example) can serve as a home bridge relay for a smart phone 2003 that is non-addressable. In this situation, the non-addressable smart phone 2003 sends a request for a relay 2032 to the network registry 2062. The network registry 2062 checks the network database 2064 and identifies an addressable smart phone 2002 that can function as a home bridge relay and adds non-addressable smart phone 2003 on a relay (addressable smart phone 2002) by name and IP. Non-addressable smart phone 2003 can then check 2044 for confidential electronic messages using the relay capabilities of addressable smart phone 2002.

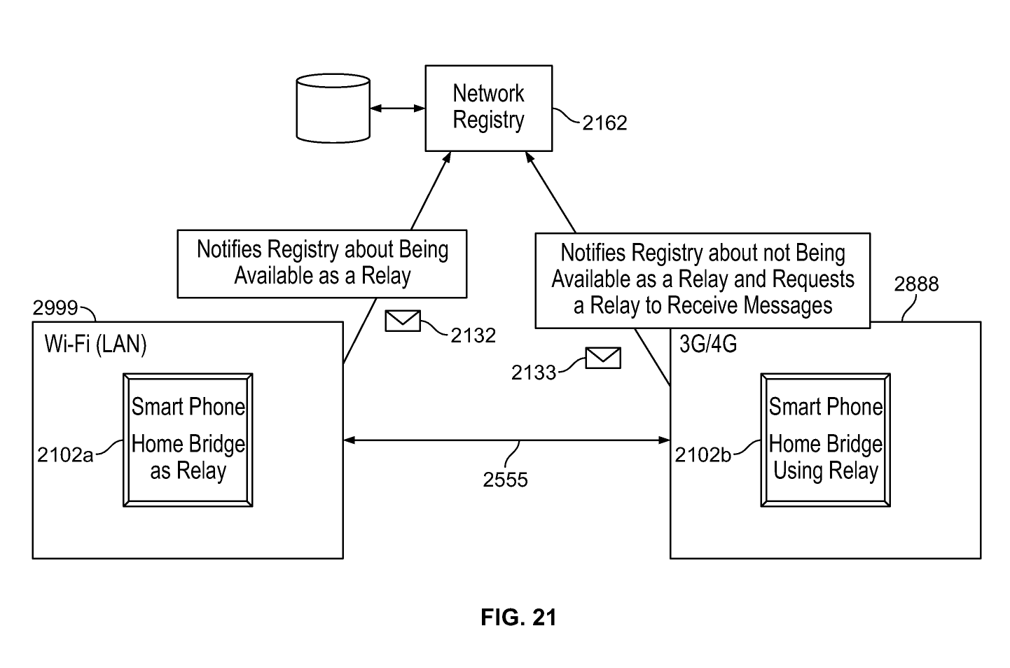

As a smart phone moves from one physical location to another, it can gain access to different wireless networks and cellular networks provided in those physical locations. As outlined above, when a smart phone (computing device) is connected via a Wi-Fi network, it can function as a home bridge itself and function as a relay for other computing devices that are not directly addressable. As shown in FIG. 21, when the smart phone 2102a is connected on a Wi-Fi network 2999, the smart phone 2102a registers 2132 with the network registry 2162 as an addressable device that can receive messages directly and one that can provide relay functionality. When the smart phone 2102a moves 2555 out of the Wi-Fi network 2999 and uses a cellular network 2888 (for example, a 3G or 4G network) for its Internet connectivity, smart phone 2102a becomes smart phone 2102b. Smart phone 2102b contacts 2133 network registry 2162 and un-registers itself as a relay and requests a relay to use from which smart phone 2102b can receive confidential messages. When moving from a cellular network to a Wi-Fi network, the process is reversed. This change of state from an addressable device that functions as a home bridge and/or home bridge relay to a non-addressable device that relies upon a home bridge relay can occur whenever the computing device moves into and out of different networks and different types of networks.

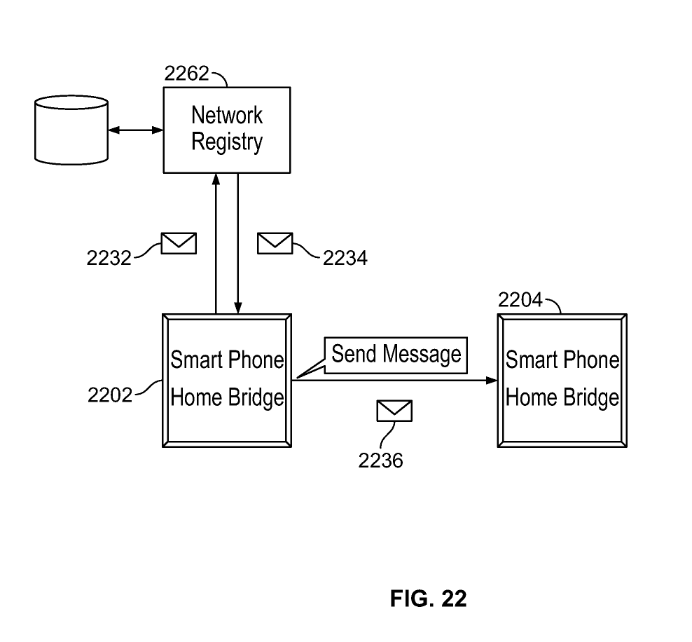

Whether a smart phone functions as a home bridge itself or relies upon another smart phone to function as a home bridge relay, confidential messages can be sent as shown in FIG. 22. FIG. 22 is similar to the scenario of FIG. 8 where a private message is sent to a member of the network, but in FIG. 22, the functionality of the home bridge device(s) is in the physical package of the smart phone(s). For example, when a user of smart phone 2202 wants to send a confidential message to the user of smart phone 2204, smart phone 2202 requests the address of the receiving smart phone 2204 by contacting 2232 network registry 2262. The network registry 2262 performs the checks described above to identify the IP address of the receiving smart phone 2204 and provides 2234 the address to the sending smart phone 2202. The sending smart phone 2202 then sends 2236 the confidential message to the receiving smart phone 2204. In this fashion, the general system and method of the claimed invention described above can be employed on mobile computing devices to effect confidential communications.

Data Transmission Between Devices

As shown in the above examples, sending computer 102, receiving computer 104, home bridge 130, and network registry 162 in these examples can run interface applications such as web browsers and others that can provide an interface to make requests for (and send data to) different web server-based applications via the computer network 199. A series of applications and services can run on the sending computer 102, receiving computer 104, home bridge 130, and network registry 162 that allow the transmission of data requested by (alternatively) sending computer 102, receiving computer 104, home bridge 130, and network registry 162. The sending computer 102, receiving computer 104, home bridge 130, and network registry 162 can provide data or receive data in response to requests directed toward the respective applications on the respective sites. In accordance with the transmission control protocol (TCP), packets can be sent between any and all of the sending computer 102, receiving computer 104, home bridge 130, and network registry 162. The packets from the sending computer 102, receiving computer 104, home bridge 130, and network registry 162 can include requests for the transmission of data. It is to be understood that the applications and services on sending computer 102, receiving computer 104, home bridge 130, and network registry 162 can be hardware or software and that sending computer 102, receiving computer 104, home bridge 130, and network registry 162 can represent sites with a single computing device or with multiple computing devices, which can include internal or external networks. Further, additional computers, sites, and servers can be coupled to the computer network 199, and many different types of applications can be available on computers, sites, and servers coupled to the computer network 199.

Types of Computing Devices

Generally, client devices such as the sending computer 102, receiving computer 104, home bridge 130, and network registry 162 can include any computing device capable of connecting to another computing device to send and receive information, including web-based information. As outlined above, the set of such devices can include devices that typically connect using a wired and/or a wireless communications medium, such as personal computers, desktops, laptops, mobile phones and/or smart phones, and the like. In these examples, the client devices can run web browsers that can provide an interface to make requests to different web server-based applications via the computer network 199. A series of web-based applications can run on the sending computer 102, receiving computer 104, home bridge 130, and network registry 162 that allow the transmission of data requested by each other and by other computing devices. The sending computer 102, receiving computer 104, home bridge 130, and network registry 162 can be further configured to engage in a secure communication with other devices coupled to the computer network 199 including additional computers, sites, and servers. Additional secure communications can be effected using mechanisms such as Secure Sockets Layer (SSL), Internet Protocol Security (IPSec), Tunnel Layer Security (TLS), and the like.

In one example, the private document delivery system 100 includes sending computer 102, receiving computer 104, home bridge 130, and network registry 162, although the system 100 can include other types of private and public networks that include other devices. Communications, such as requests from sending computer 102, receiving computer 104, home bridge 130, and network registry 162 and responses from each take place over the computer network 199 according to standard network protocols, such as the HTTP and TCP/IP protocols, but the principles discussed are not limited to this example and can include other protocols.

Further, the system 100 can include local area networks (LANs), wide area networks (WANs), direct connections and any combination thereof, other types and numbers of network types, including peer-to-peer networks, for example. On an interconnected set of LANs or other networks, including those based on different architectures and protocols, routers, switches, hubs, gateways, bridges, and other intermediate network devices can act as links within and between LANs and other networks to enable messages and other data to be sent from and to network devices. Also, communication links within and between LANs and other networks typically include twisted wire pair (e.g., Ethernet), coaxial cable, analog telephone lines, full or fractional dedicated digital lines including T1, T2, T3, and T4, Integrated Services Digital Networks (ISDNs), Digital Subscriber Lines (DSLs), wireless links including satellite links and other communications links known to those skilled in the relevant arts. In essence, the computer network 199 includes any communication medium and method by which data can travel between sending computer 102, receiving computer 104, home bridge 130, and network registry 162, and these example configurations are provided by way of example only.

Description of Computer Components

Each of the sending computer 102, receiving computer 104, home bridge 130, and network registry 162 can include a central processing unit (CPU), controller or processor, a memory, and an interface system which are coupled together by a bus or other link, although other numbers and types of each of the components and other configurations and locations for the components can be used.

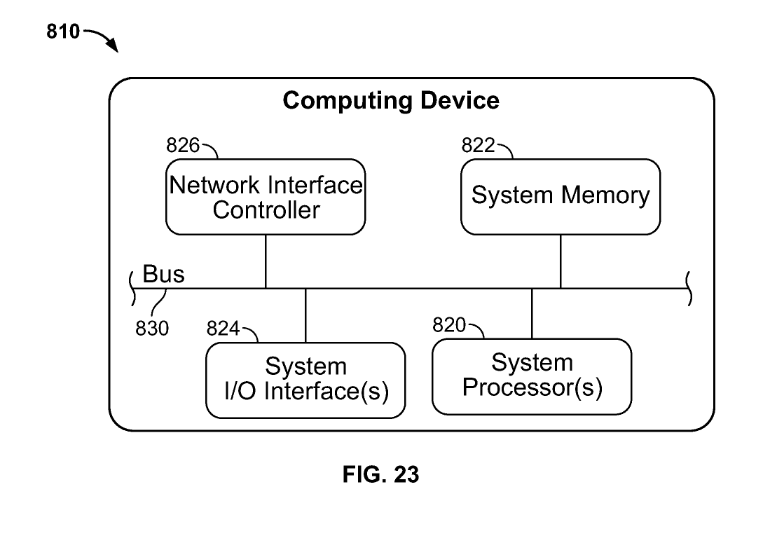

As shown further in FIG. 23, the confidential electronic document computing devices of the claimed invention, including the sending computer 102, receiving computer 104, home bridge 130, and network registry 162 are shown as an example “computing device” 810. Computing device 810 includes system processor(s) 820, system memory 822, system I/O interface(s) 824, and network interface controller 826, which are coupled together by a bus 830 or other numbers and types of links, although the confidential electronic document computing devices 810 can include other components and elements in other configurations. In this example, the confidential electronic document computing device 810 is implemented as a standalone device, although the confidential electronic document computing devices 810 could be implemented as blade devices in a chassis-blade implementation, for example.

System processor 820 includes one or more microprocessors configured to execute computer/machine readable and executable instructions stored in system memory 822 to implement automatic sending and receiving of confidential electronic documents on a client server network system, such as system 100, for example. When executed by at least one processor, the instructions stored in system memory 822 cause the processor 820 to automatically send and receive confidential electronic documents. The instructions on the computer readable medium, including system memory 822, further cause the processor 820 to perform steps including sending a confidential electronic document between a sending computer 102 and a receiving computer 104.

The system processor 820 is configured to execute computer/machine readable and executable instructions stored in system memory 822 to implement one or more portions of the processes described above and further below in connection with FIGS. 1-22, for example, although processor 820 can comprise other types and/or combinations of processors, such as digital signal processors, micro-controllers, switch chips, bus controllers, application specific integrated circuits (“ASICs”), programmable logic devices (“PLDs”), field programmable logic devices (“FPLDs”), field programmable gate arrays (“FPGAs”), and the like, programmed or configured according to the teachings as described and illustrated with respect to FIGS. 1-22.

System memory 822 includes computer readable media, namely computer readable or processor readable storage media, which are examples of machine-readable storage media. Computer readable storage/machine-readable storage media can include volatile, nonvolatile, removable, and non-removable media implemented in any method or technology for storage of information, such as computer readable/machine-executable instructions, data structures, program modules, or other data, which can be obtained and/or executed by one or more processors, such as system processor 820, to perform actions, including implementing an operating system for controlling the general operation of confidential electronic document computing device 810 to automatically send a confidential electronic document in accordance with the processes described above in connection with FIGS. 1-22, for example.

Examples of computer readable storage media include RAM, BIOS, ROM, EEPROM, flash/firmware memory or other memory technology, CD-ROM, digital versatile disks (DVD) or other optical storage, magnetic cassettes, magnetic tape, magnetic disk storage or other magnetic storage devices, or any other medium which can be used to store the desired information, including data and/or computer-executable instructions or other machine-executable instructions, and which can be accessed by a computing or specially programmed device, such as confidential electronic document computing devices 810. When the instructions stored in system memory 822 are run by the system processor 820, the confidential electronic document computing device 810 implements at least a portion of the processes described further below to send confidential electronic documents in connection with FIGS. 1-22, in addition to the various client-server management related functions, including redundancy functions, version controls, server load balancing functions, device configuration functions (e.g., defining network security policies), VPN hosting, network traffic management, loss control, and other functions.

System I/O interface(s) 824 includes one or more user input and output device interface mechanisms, such as a computer keyboard, mouse, display device, and the corresponding physical ports and underlying supporting hardware and software to enable the confidential electronic document computing devices 810 to communicate with the outside environment for accepting user data input and to provide user output, although other types and numbers of user input and output devices can be used. Alternatively or in addition, as will be described in connection with network interface controller 826 below, the confidential electronic document computing devices 810 can communicate with the outside environment for certain types of operations (e.g., configuration) via a network management port, for example.

Network interface controller 826 provides physical access to a networking medium and provides a low-level addressing system, which enables the confidential electronic document computing devices 810 to engage in TCP/IP communications over network system 100 (shown in FIG. 1) and to automatically deliver confidential documents to receiving computers and to maintain application services although the network interface controller 826 can be constructed for use with other communication protocols and types of networks, and can include other components, and can perform other functions. Network interface controller 826 is sometimes referred to as a transceiver, transceiving device, or network interface card (NIC), which transmits and receives network data packets to one or more networks, such as system 100 in this example. When the confidential electronic document computing device 810 includes more than one system processor 820 (or a processor 820 has more than one core), each processor 820 (and/or core) can use the same single network interface controller 826 or a plurality of network interface controllers 826. Further, the network interface controller 826 can include one or more physical ports, such as Ethernet ports, to couple the confidential electronic document computing devices 810 with other network devices, such as servers and other sites. Additionally, the network interface controller 826 can include certain physical ports dedicated to receiving and/or transmitting certain types of network data, such as device management related data for configuring the confidential electronic document computing devices 810.

In one example, the network interface controller 826 is an FPGA that can include a local memory and be configured with logic to implement one or more aspects of the technology, including by way of example only, automatically sending and receiving confidential electronic documents, although the network interface controller 826 can include other types of configurable hardware, such as digital signal processors, micro-controllers, ASICs, PLDs, FPLDs, and the like, programmed or configured according to the teachings as described and illustrated herein with respect to FIGS. 1-22, as well as software executed by the system processor 820, combinations thereof, and other components and elements configured in other manners which could implement one or more aspects of the technology. The use of specialized hardware in this example allows the network interface controller 826 to rapidly process network data packets.

Bus 830 includes at least one internal device component communication bus, link, bridge and supporting components, such as bus controllers and/or arbiters. These devices enable the various components of the confidential electronic document computing device 810, such as the system processor 820, system memory 822, system I/O interface 824, and network interface controller 826, to communicate, although the bus 830 can enable one or more components of the confidential electronic document computing device 810 to communicate with components in other devices as well. By way of example only, example buses include HyperTransport, PCI, PCI Express, InfiniBand, USB, Firewire, Serial ATA (SATA), SCSI, IDE and AGP buses, although other types and numbers of buses can be used, and the particular types and arrangement of buses will depend on the particular configuration of confidential electronic document computing device 810.

While each of the computers and verification agent can include the processor 820, memory 822, network interface controller 826, and I/O interface 824 coupled together by a bus 830, two or more computing systems or devices can be substituted for any one of the devices in the system 100. Accordingly, principles and advantages of distributed processing, such as redundancy, replication, and the like, also can be implemented as desired to increase the robustness and performance of the devices and systems of the system 100. The system 100 can also be implemented on a computer system or systems that extend across any network environment using any suitable interface mechanisms and communications technologies including, for example telecommunications in any suitable form (e.g., voice, modem, and the like), Public Switched Telephone Network (PSTNs), Packet Data Networks (PDNs), the Internet, intranets, a combination thereof, and the like.

As outlined above, each of the client computers, sites, and servers can include a central processing unit (CPU), controller or processor, a memory, and an interface which are coupled together by a bus or other link, although other numbers and types of each of the components and other configurations and locations for the components can be used. The processors in the computing devices can execute a program of stored instructions for one or more aspects of the methods and systems as described herein, although the processor could execute other types of programmed instructions. The memory can store these programmed instructions for one or more aspects of the methods and systems as described herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory. The user input device can include a computer keyboard and a computer mouse, although other types and numbers of user input devices can be used. The display can include a computer display screen, such as a CRT or LCD screen by way of example only, although other types and numbers of displays could be used.

Although an example of the confidential electronic document computing devices 810 are described and illustrated in connection with FIG. 23, each of the computers and computing devices of the system 100 could be implemented on any suitable computer system or computing device. It is to be understood that the example devices and systems of the system 100 are for exemplary purposes, as many variations of the specific hardware and software used to implement the system 100 are possible, as will be appreciated by those skilled in the relevant art(s).

Further, each of the devices of the system 100 can be conveniently implemented using one or more general purpose computer systems, microprocessors, digital signal processors, micro-controllers, application specific integrated circuits (ASIC), programmable logic devices (PLD), field programmable logic devices (FPLD), field programmable gate arrays (FPGA) and the like, programmed according to the teachings as described and illustrated herein, as will be appreciated by those skilled in the computer, software, and networking arts.

The operation of example processes to provide a system and method of delivering confidential electronic files shown in FIGS. 1-22 can be run on the private document delivery system 100. The flow diagrams of FIGS. 1-22 are representative of example machine readable instructions for implementing the process of delivering confidential electronic files. The steps described above are example machine readable instructions for implementing a method in accordance with the examples described in this disclosure. In one example, the machine readable instructions include an algorithm for execution by: (a) a processor, (b) a controller, and/or (c) one or more other suitable processing device(s). The algorithm can be instantiated in software stored on tangible media such as, for example, a flash memory, a CD-ROM, a floppy disk, a hard drive, a digital video (versatile) disk (DVD), or other memory devices, but persons of ordinary skill in the art will readily appreciate that the entire algorithm and/or parts thereof could alternatively be executed by a device other than a processor and/or embodied in firmware or in dedicated hardware in a known manner. For example, the algorithm can be implemented by an application specific integrated circuit (ASIC), a programmable logic device (PLD), a field programmable logic device (FPLD), a field programmable gate array (FPGA), discrete logic, etc.). For example, any or all of the components of the private document delivery system could be implemented by software, hardware, and/or firmware. Also, some or all of the machine readable instructions described herein can be implemented manually. Further, although an example of the present invention is described and illustrated herein, persons of ordinary skill in the art will readily appreciate that many other methods of implementing the example machine readable instructions can alternatively be used. For example, the order of execution can be changed, and/or some of the steps described can be changed, eliminated, or combined.

By performing a method of delivering confidential electronic files using a system described above, if a sender wishes to send a confidential electronic document, such as an email, message, document, or attachment, a direct path for the transmission and reception of the restricted electronic document is accomplished and the document is delivered securely.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as can be specified in the claims. Accordingly, the invention is limited only by the following claims and equivalents thereto.

What is claimed is:

1. A method of sending a private message over a computer network comprising:
storing an outbound private message in a home bridge of a sending computer;
requesting confirmation from a network registry that a receiving computer is a member of the computer network;
receiving location information of the receiving computer from the network registry upon confirmation that the receiving computer is a member of the computer network;
receiving on-line status information of the receiving computer from the network registry;
sending a message waiting notification to provide notice to the receiving computer that a private message is awaiting when the received on-line status of the receiving computer indicates that the receiving computer is unavailable; and
delivering the private message from the home bridge to the receiving computer when the receiving computer becomes available.

2. The method of claim 1, wherein the home bridge is a personal digital mailbox under control of a user of the sending computer.

3. The method of claim 1, wherein the home bridge is one of a plug computer, a personal computer, or a server.

4. The method of claim 1, wherein the home bridge stores outbound private messages from a plurality of sending computers.

5. The method of claim 1, wherein delivering the private message from the home bridge of the sending computer to the receiving computer includes storing the private message on a home bridge of the receiving computer.

6. The method of claim 5, wherein the home bridge of the receiving computer stores private messages for delivery to a plurality of receiving computers.

7. The method of claim 1, wherein the home bridge is a smart phone or a tablet computer.

8. The method of claim 7, wherein the message waiting notification is sent via at least one of short message service (SMS), email, or Instant Message (IM).

9. The method of claim 8 further comprising:
waking up the home bridge to affect delivery of the private message using at least one of Wake-on-LAN and Wake on Wireless LAN.

10. The method of claim 1, wherein delivering the private message from the home bridge directly to the receiving computer occurs when the sending computer is not on-line.

11. The method of claim 1, wherein the private message is composed using at least one of a non-private email client, a non-private web mail service, and a non-private instant messaging service.

12. The method of claim 1, wherein storing the outbound private message in the home bridge device includes selecting an email client plug-in to automatically place the outbound private message on the home bridge appliance.

13. The method of claim 1 further comprising:
delivering a notification message to the receiving computer including an embedded link from the network registry that, when activated, locates the home bridge that has the private message;
receiving a private message request upon activation of the embedded link; and
delivering the private message to the receiving computer.

14. The method of claim 13 further comprising:
receiving at least one of receiving computer verification information and receiving user verification information; and
verifying at least one of receiving computer verification information and receiving user verification information meets verification criteria in at least one of the network registry and the sending computer.

15. The method of claim 1 further comprising:
forwarding the outbound private message with a relay home bridge when the receiving computer is not directly addressable.

16. The method of claim 15 further comprising:
assigning the relay home bridge using a central relay registry.

17. The method of claim 15 further comprising:
temporarily storing the private message in the relay home bridge.

18. The method of claim 15 further comprising:
streaming the private message from the home bridge of the sending computer to the relay home bridge without storing the private message; and
streaming the private message from the relay home bridge to a home bridge of the receiving computer.

19. The method of claim 1, wherein delivering the private message includes:
hole punching a firewall of the receiving computer when the receiving computer is not directly accessible.

20. The method of claim 1, wherein delivering the private message includes:
storing the private message in a receiver home bridge remotely accessible by a user from other network locations.

21. The method of claim 1 further comprising:
determining when a recipient of the private message on a receiving computer is a member of the private computer network.

22. The method of claim 21, wherein the sending computer is a member of the private messaging network and the receiving computer is a non-member of the private messaging network, and the receiving computer is notified through a non-private message to directly access the private message from the home bridge of the sending computer.

23. The method of claim 22, further comprising:
specifying an authentication, by the sending computer, to ensure the private message is delivered to the correct receiving computer.

24. The method of claim 23, wherein specifying the authentication includes the sending computer specifying a single use unique id which expires in a predetermined amount of time.

25. The method of claim 23, wherein the authentication includes the sending computer providing an authentication to the receiving computer separate from the non-private message indicating that a private message is waiting for the receiving computer.

26. The method of claim 23, wherein specifying the authentication includes the sending computer providing an authentication to the receiving computer notified with the non-private message indicating that a private message is waiting for the receiving computer to access.

27. The method of claim 26, wherein the authentication provided to the receiving computer includes a password with which the receiving computer gains access to the waiting private message.
